(19) United States
(12) Patent Application Publication
(10) Pub. No.: US 2022/0169166 A1
(43) Pub. Date: Jun. 2, 2022

(54) Higher Capacity Vehicle Trailer

(71) Applicant: William Payson, Atlanta, GA (US)

(72) Inventor: William Payson, Atlanta, GA (US)

(21) Appl. No.: 17/540,170

(22) Filed: Dec. 1, 2021

Related U.S. Application Data
(60) Provisional application No. 63/119,835, filed on Dec. 1, 2020.

(51) Int. Cl. B60P 1/52

(52) U.S. Cl. CPC B60P 1/52; B60S 9/02

(57) ABSTRACT

Systems and methods are provided for designing and loading a higher capacity enclosed trailer. The higher capacity trailer includes a trailer floor including at least two sections. The at least two sections include a first section located at a first end of the high capacity trailer and having a first height, and a second section located at a second end of the high capacity vehicle trailer opposite the first end, the second section having a second height different from the first height. The higher capacity trailer includes an adjustable platform positioned at the first section. The adjustable platform is configured to receive at least one loaded pallet unit, and slide a predetermined length of the first section towards the first end, such that additional space is generated for at least another loaded pallet unit on the first section.

### RELATED APPLICATION

This application claims priority to U.S. Provisional Patent Application No. 63/119,835, filed Dec. 1, 2020, entitled “Higher Capacity Vehicle Trailer,” which is hereby incorporated by reference in its entirety.

### TECHNICAL FIELD

The disclosed implementations relate generally to a trailer and load system(s) that are used to load and transport more freight, including more palletized freight, than standard trailers and conventional loading methods.

### BACKGROUND

Transportation units, such as trucks; tractor trailers; intermodal containers; trains; cars; or containers, are used to transport large quantities of goods. In fact, it is estimated that about 70% of freight transported in the United States is via truck. Existing trailer designs and their use have significant limitations that reduce efficiency. As an example, US Department of Transportation (DOT) data shows that most loaded Class 8 heavy duty trucks are less than half full of cargo by weight, and visual inspection of loaded tractor trailers often shows the top half of the transportation unit is empty.

Prior attempts to increase the available cubic capacity of trailers have involved design tradeoffs that made such higher capacity trailers poorly suited to handle many types of freight, including palletized freight, and resulted in higher capacity trailers being limited to niche applications, such as moving household goods which are mainly loaded by hand, and other lightweight, low density freight, such as assembled furniture, water tanks, and potato chips that can be handled without a forklift.

Given the current inefficiencies and waste in freight transportation, better trailer designs, load systems and processes are needed to enable the use of higher capacity trailers to handle a broader range of freight. Desired characteristics for such trailers include increased cubic capacity, the ability to handle palletized freight to enable general use, and efficient loading systems and processes to load all available cubic capacity with as much freight as possible. The inventions described herein enable the transportation of more freight on fewer trucks, thereby reducing transportation costs and greenhouse gas emissions.

### SUMMARY

The systems and methods described herein provide new, flexible, and more efficient ways to increase the available capacity of a trailer, to efficiently load the available capacity of a trailer to increase the average freight load per trailer, to enable forklift or mechanical loading of the trailer, and to enable the handling of a wide range of freight types (e.g., palletized, oversized, loose, unitized). Combining these innovations into a trailer and/or load system(s) significantly increases the economic utility of the trailer, and takes advantage of the benefits of higher capacity trailers used across a wider range of freight transportation types.

According to various implementations, a high capacity vehicle trailer includes a trailer floor including at least two sections. The at least two sections include a first section located at a first end of the high capacity trailer, the first section having a first height; and a second section located at a second end of the high capacity vehicle trailer opposite the first end, the second section having a second height different from the first height. The high capacity vehicle trailer further includes an adjustable platform positioned at the first section, the adjustable platform configured to receive at least one loaded pallet unit, and slide a predetermined length of the first section towards the first end, such that additional space is generated for at least another loaded pallet unit on the first section.

In some implementations, the first section includes a channel extending along the predetermined length, and the adjustable platform includes one or more wheels configured to slide along a path of the channel. In some implementations, the channel includes at least two rails, and the one or more wheels of the adjustable platform rest on the at least two rails. In some implementations, the trailer floor of the first section is made of a low friction material configured to allow the adjustable platform to slide at least partially the first length of the first section towards the first end of the high capacity vehicle trailer with a predetermined force. The predetermined force being less than a substantial force. In some implementations, the trailer floor of the first section includes a plurality of rollers configured to allow the adjustable platform to be moved at least partially across the first length of the first section towards the first end of the high capacity vehicle trailer with a predetermined force, the predetermined force being less than a substantial force.

In some implementations, the adjustable platform includes an inner platform and an outer platform, the outer platform being configured to be loaded first and slide the predetermined length of the first section towards the first end before the inner platform is loaded. In some implementations, the inner platform is configured to be slide another predetermined length of the first section towards the first end of the high capacity vehicle trailer, the other predetermined length being less than the predetermined length. In this way, the additional space is generated for at least the other loaded pallet unit on the first section.

In some implementations, the first section of the high capacity vehicle trailer is configured to receive at least three rows of loaded pallets. In some implementations, the first section of the high capacity vehicle trailer includes a locking mechanism for securing the adjustable platform. In some implementations, the second section of the high capacity vehicle trailer includes at least two wheel wells that occupy at least a portion of an interior of the vehicle trailer. In some implementations, the second height of the second section of the high capacity vehicle trailer is lower than a height of the top of the at least two wheel wells. In some implementations, the at least two wheel wells are separated by a width of a forklift or a width wider than the width of the forklift (e.g., an aisle wider than the width of the forklift). In some implementations, the first of the first section of the high capacity vehicle trailer and the second height of the second section of the high capacity vehicle trailer are fixed. In some implementations, the first height of the first section of the high capacity vehicle trailer is greater than the second height of the second section of the high capacity vehicle trailer.

In some implementations, the high capacity vehicle trailer includes a third section between the first section and second section. The third section includes a third end and a fourth end, the third end being adjacent to the first section of the high capacity vehicle trailer, and the fourth end being adjacent to the second section of the high capacity vehicle trailer. The third end has a third height less than the second height of the second section of the high capacity vehicle trailer. The fourth end has the same height as the second height of the second section of the high capacity vehicle trailer.

In some implementations, the high capacity vehicle trailer includes a lifting mechanism near the second section of the high capacity vehicle trailer. The lifting mechanism is configured to raise the trailer such that the rear interior floor of the second section of trailer is level with a loading dock. In some implementations, the lifting mechanism is an airbag, hydraulic, or electric mechanical lift. In some implementations, the lifting mechanism is an extendable jack.

In some implementations, the high capacity vehicle trailer includes at least one of a digital camera system and telematics device configured to provide data on the loading and unloading operation of the trailer. In some implementations, the telematics device is configured to capture, from one or more pallets, data corresponding to at least one of handling equipment and cargo loaded or unloaded from the trailer.

In some implementations, a first wall of the high capacity vehicle trailer includes a first plurality of supports, and a second wall of the high capacity vehicle trailer includes a second plurality of supports. A first adjustable support member is configured to be coupled to a first support of the first plurality of supports and a second support of the second plurality of supports. The first adjustable support member is configured to receive (and support) another loaded pallet unit. In some implementations, the first support and the second support share the same axis. In some implementations, the first adjustable support member is collapsible. In some implementations, a second adjustable member is coupled to a third support of the first plurality of supports and a fourth support of the second plurality of supports, and the second adjustable support member is configured to secure the other loaded pallet unit.

According to various implementations, a method of loading a high capacity vehicle trailer includes defining a capacity of the high capacity vehicle trailer. The method includes obtaining transportation data including information on planned goods to be transported. The method includes analyzing the transportation data to determine a configuration for loading a plurality of units of goods onto the higher capacity vehicle trailer, and determining whether the configuration includes loading the plurality of units of goods into a pallet rack. The method further includes providing loading instructions corresponding to the determined loading configuration, the loading instructions specifying whether to load the plurality of units of goods into a pallet rack.

In some implementations, defining the capacity of the high capacity vehicle trailer includes dividing the at least two section into subsections. In some implementations, defining the capacity of the high capacity vehicle trailer includes dividing the at least two section into units of capacity. In some implementations, defining the capacity of the high capacity vehicle trailer includes defining respective load options for the at least two section.

In some implementations, the information on planned goods to be transported includes a predetermined number of a plurality of units of goods to be loaded in the high capacity trailer. In some implementations, the loading configuration includes an arrangement of the plurality of goods. In some implementations, the arrangement of the plurality of goods includes a respective predetermined numbers of loaded pallets to be loaded within the at least two sections of the high capacity trailer.

According to various implementations, a method of determining loading configurations of a high capacity vehicle trailer includes receiving shipment data. The method further includes receiving trailer capacity data, and determining, based on the shipment data and the trailer capacity data, a number of high capacity trailers required. The method includes determining, based on the shipment data and the trailer capacity data, a number and configuration of loaded pallets required to fill the trailer. The shipment instructions are then provided to a user (e.g., a shipper or a carrier). In some implementations, determining the number of required loaded pallets includes assigning one or more pallet racks to one or more shipments. In some implementations, determining the number of required loaded pallets includes assigning predetermined load positions to one or more loaded pallets assigned to one or more shipments.

In some implementations, the method includes receiving video data corresponding to a high capacity vehicle trailer, and determining whether the high capacity vehicle trailer is loaded, and if so how fully and well loaded. In some implementations, the method includes receiving, from one or more shipments with telematics devices, additional shipment data. In some implementations, determining the number of high capacity trailers required is further based on the additional shipment data, and determining the number of loaded pallets required is further based on the additional shipment data.

In some implementations, the method includes periodically determining the number of high capacity trailers and the number of required loaded pallets. In some implementations, the method includes determining unused capacity of one or more high capacity vehicle trailers. In some implementations, the method includes providing a notification to a user, the notification including information on the unused capacity of the one or more high capacity trailers. In some implementations, the method includes determining placement of a shipment in a high capacity vehicle trailer or pallet based on the shipment data. In some implementations, the method includes determining placement of a second shipment in a high capacity vehicle trailer or pallet based on the placement of a first shipment.

According to various implementations, a method of loading a high capacity vehicle trailer includes receiving at least one loaded pallet unit on the adjustable platform, and sliding the adjustable platform a predetermined length of the first section towards the first end of the high capacity vehicle trailer, such that additional space is generated for at least another loaded pallet unit on the first section. In some implementations, the high capacity vehicle trailer includes a trailer floor including at least two sections. The at least two sections include a first section located at a first end of the high capacity trailer, the first section having a first height, and a second section located at a second end of the high capacity vehicle trailer opposite the first end. The second section has a second height different from the first height. In some implementations, the high capacity vehicle trailer further includes an adjustable platform positioned at the first section, the method includes

In some implementations, the adjustable platform includes an inner platform and an outer platform, and the method further includes receiving a first loaded pallet unit of the at least one loaded pallet unit on the outer platform. The method further includes sliding the outer platform the predetermined length of the first section towards the first end, and receiving a second loaded pallet unit of the at least one loaded pallet unit on the inner platform. In some implementations, the method includes sliding the inner platform another predetermined length of the first section towards the first end, the other predetermined length being less than the predetermined length, such that the additional space is generated for at least the other loaded pallet unit on the first section.

In some implementations, the method includes receiving at least three rows of loaded pallet units on the first section of the high capacity vehicle trailer. In some implementations, the first section of the high capacity vehicle trailer includes a locking mechanism, and the method further includes securing the adjustable platform to the first section. In some implementations, the high capacity vehicle trailer includes a lifting mechanism near the second section, and the method further includes raising the second section such that it is level with a loading dock. In some implementations, the high capacity vehicle trailer includes a plurality of supports, and the method further includes coupling an adjustable support to the plurality of supports.

Other aspects include corresponding systems, apparatuses, and computer program products for implementation of the computer-implemented method.

Various implementations of systems, methods, and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description,” one will understand how the features of various implementations are used.

### BRIEF DESCRIPTION OF THE DRAWINGS

For a better understanding of the aforementioned aspects of the invention, as well as additional aspects and implementations thereof, reference should be made to the Description of Implementations below, in conjunction with the following drawings in which like reference numerals refer to corresponding parts throughout the figures.

FIG. 1 illustrates a conventional prior art system for loading a transportation unit with palletized freight and/or other unpalletized freight.

FIG. 2A-2D illustrates different views of a drop deck vehicle trailer, in accordance with some implementation

FIGS. 3A and 3B illustrate top views of an adjustable platform 25, in accordance with some implementations.

FIGS. 4A-4C illustrate side views of an adjustable platform, in accordance with some implementations.

FIGS. 5A and 5B illustrate different views of the adjustable platform loaded with a pallet rack, in accordance with some implementations.

FIGS. 6A-6C illustrate different views of a conveyor mechanism, in accordance with some implementations.

FIGS. 7A-7C illustrate different views of an alternate conveyor mechanism, in accordance with some implementations.

FIGS. 8A and 8B illustrate an alternate method of loading a first section of the drop deck vehicle trailer.

FIGS. 9A and 9B illustrate another alternative method of loading the first section.

FIG. 10 illustrates a rear view of a loaded drop deck vehicle trailer, in accordance with some implementations.

FIGS. 11A-11C are different views of a deep drop deck vehicle trailer, in accordance with some implementations.

FIG. 12 illustrates a rear view of a loaded drop deck vehicle trailer, in accordance with some implementations.

FIG. 13 illustrates a rear view of a loaded deep drop deck vehicle trailer, in accordance with some implementations.

FIG. 14 illustrates a another rear loading view, in accordance with some implementations.

FIGS. 15A and 15B illustrate a first and second plurality of supports, in accordance with some implementations.

FIGS. 16A and 16B illustrates different lift mechanisms, in accordance with some implementations.

FIG. 17 illustrates an alternative drop deck vehicle trailer with at least three sections, in accordance with some implementations.

FIG. 18 is a flow chart illustrating a method for loading a high capacity vehicle trailer, in accordance with some implementations.

FIGS. 19A-19B are flow charts illustrating a method for assigning shipments to a high capacity vehicle trailer, in accordance with some implementations.

FIG. 20 is a flow chart illustrating a method of loading or unloading a high capacity vehicle trailer, in accordance with some implementations.

Like reference numerals refer to corresponding parts throughout the drawings.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the present implementations. However, it will be apparent to one of ordinary skill in the art that the present various implementations may be practiced without these specific details. In other instances, well-known components and methods have not been described in detail so as not to unnecessarily obscure aspects of the implementations.

It will also be understood that, although the terms first, second, etc. may be used herein to describe various elements, these elements should not be limited by these terms. These terms are only used to distinguish one element from another e.g., first side panel and second side panel. For example, a first element could be termed a second element, and, similarly, a second element could be termed a first element, without changing the meaning of the description, so long as all occurrences of the first element are renamed consistently and all occurrences of the second element are renamed consistently. The first element and the second element are both elements, but they are not the same element.

The terminology used in the description of the implementations herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” as well as the terms “includes” and/or “including” when used in this specification, specify the presence of stated features, integers, steps, operations, elements, and/or components, but do not preclude the presence or addition of one or more other features, steps, elements, components, and/or groups thereof. Furthermore, as used herein, the term “if” may be construed to mean “when” or “upon” or “in response to,” depending on the context.

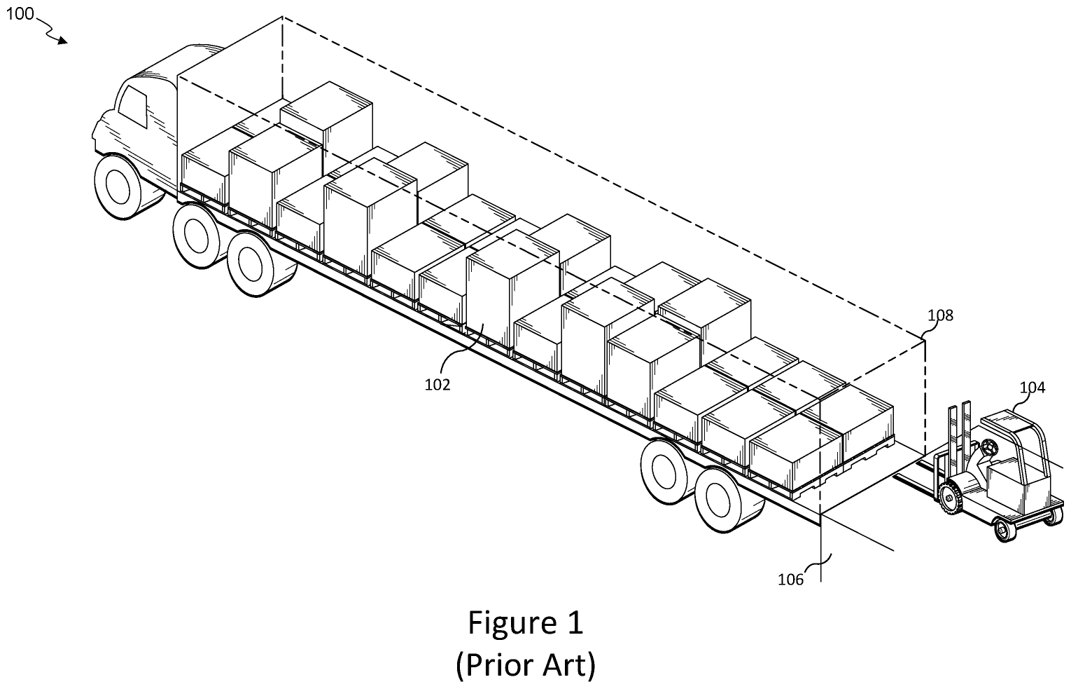

FIG. 1 illustrates an existing conventional vehicle trailer 100. The conventional vehicle trailer 100 is configured to be loaded or unloaded with one or more loaded or unloaded pallets, pallet racks, unitized cargo, and/or other freight (generally referred to as a loaded pallet(s) 102) via a forklift 104. In some implementations, the forklift 104 accesses the conventional vehicle trailer 100 via a freight loading dock 106. Typically, a forklift 104 is used to load or unload conventional vehicle trailers 100. For purposes of this disclosure, the forklift 104 includes motorized or non-motorized devices or vehicles used to lift and move loaded pallets 102. A non-exhaustive list of forklifts 104 includes forklifts, pallet jacks, walkies, automated forklift, and freight handling robots. In some implementations, a forklift 104 includes two prongs for engaging slots of loaded pallets 102. Alternatively, in some implementations, a forklift 104 does not include any prongs, and instead lifts and moves a loaded pallet 102 from underneath the pallet base.

Conventional vehicle trailers 100 have varying sizes and measurements depending on region. For example, conventional vehicle trailers 100 in the US can have different sizes and measurements than those in Europe or Asia. The trailer sizes and measurements described below are non-limiting and provided for illustration purposes. In the US, conventional vehicle trailers 100 can include a cargo compartment 108. The cargo compartment 108 can have a length of approximately 40 ft., 45 ft., 48 ft., or 53 ft. (+/−1 ft.) long. Alternatively, the cargo compartment 108 can be a single trailer length, such as 28 ft., or designed for use in twin trailer Combination Vehicle systems and be 28 or 33 ft. long. Typically, the conventional vehicle trailers 100 have an exterior height of approximately 13 ft, 6 in.(+/−6 in.) (e.g., measured from the ground to the top of the cargo compartment 108). Variations of the conventional vehicle trailers 100 can have an exterior height of approximately 14 ft. (+/−6 in.). The cargo compartment 108 can have an internal height of approximately 9 ft., 6 in. (+/−6 in.). The cargo compartment can have an interior width between 98 in. and 102 in., inclusive. In general, conventional vehicle trailers 100 in the US can provide an upper limit of approximately 4,000 available cubic feet of cargo capacity in the cargo compartment 108 (under current US Federal and State regulatory limits on the length of trailer, the width of a trailer, and the height of the ceiling on the conventional vehicle trailers 100).

In FIG. 1, the conventional vehicle trailer 100 is backed against the freight loading dock 106. In the US, the freight loading dock 106 has a standard height of 48 in. above ground. Customized, specialized, or region specific freight loading docks 106 have heights greater than or less than the standard US height of 48 in. Typically, to enable forklift loading and unloading, the conventional vehicle trailer's 100 trailer floor must be at about the same height as the freight loading dock 106. In some cases, slight variations (e.g. 6 in.) in height difference between the trailer floor and the freight loading dock 106 can be accommodated by a dock plate (not shown). The dock plate is configured to bridge the gap between the conventional vehicle trailer 100 and freight dock. In cases where the height difference between the trailer floor and the freight loading dock 106 is substantial (e.g., greater than 6 in.), conventional vehicle trailer 100 would not be accessible to the forklift 104 unless other adjustments were made (e.g., use of a customized freight loading dock 106, adjustments to the heights of the freight loading dock 106 and/or the trailer floor, loading or unloading from the ground, etc.).

Typically, conventional vehicle trailers 100 in the US are configured to have a floor height of 48 in. The typical floor height (48 in.) of conventional vehicle trailers 100 and the flat surface of the trailer floors provide easy access, via standard freight loading dock 106, to the forklift 104 for loading and unloading of loaded pallets 102. Further, conventional vehicle trailers 100 have two solid axles (not shown), a suspension, and tires 110 in the rear. Some variations of the conventional vehicle trailers 100 have 3 or more axles to accommodate special cargos, which are typically configured with two tires on either side of the axle on each axle, for a total of 8 rear tires. Trailers 28 ft. and 33 ft. long designed for use in combination vehicles (a tractor pulling two trailers) often have a single rear axle.

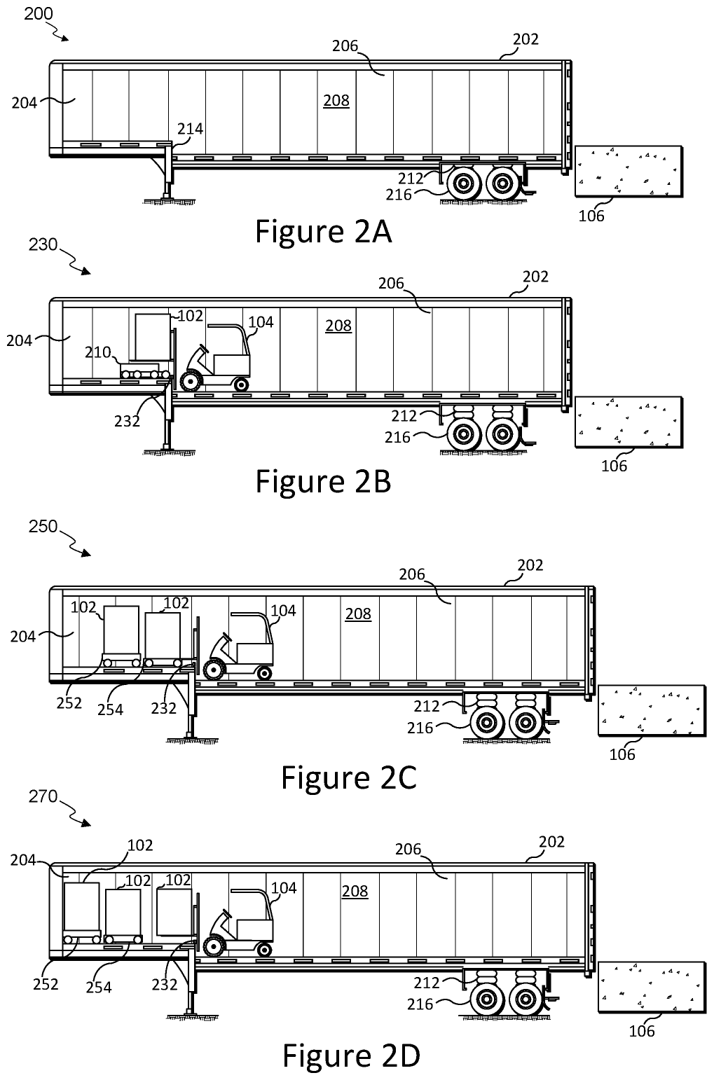

FIG. 2A-2D illustrates different views of a drop deck vehicle trailer, in accordance with some implementation. A first view 200 shows the drop deck vehicle trailer 202 with a trailer floor including at least two sections including a first section 204 (e.g., a front section near the nose of the drop deck vehicle trailer 202) and a second section 206 (e.g., a rear section near the loading end of the drop deck vehicle trailer 202), the second section 206 opposite the first section 204. The drop deck vehicle trailer 202 further includes a cargo compartment 208 (defined by the at least two sections), an adjustable platform 210, and a lift mechanism 212. The first section 204 rests on top of the truck tractor and a kingpin while being transported, and drops down to a lower height floor section for the second section 206. The drop deck vehicle trailer 202 is configured to be loaded or unloaded with one or more loaded or unloaded pallets, pallet racks, unitized cargo, and/or other freight (generally referred to as a loaded pallet(s) 102) via a forklift 104. The forklift 104 can access the drop deck vehicle trailer 202 via a freight loading dock 106.

The drop deck vehicle trailer 202 can be configured in different trailer sizes and measurements. The trailer sizes and measurements described below are non-limiting and provided for illustration purposes. In some implementations, the trailer sizes and measurements vary by region or other markets. For example, trailer sizes and measurements for US trailers may be distinct from those in Europe and/or Asia. Example trailer sizes and measurements are described above in FIG. 1.

In some implementations, the first section 204 has a first height and the second section 206 has a second height, different from the first height. In some implementations, the first height is greater than the second height (relative to the ground). In some implementations, the first height and the second height are fixed. The first section 204 has a first predetermined length, and the second section 206 has a second predetermined length. In some implementations, the first predetermined length is equal to the distance from the nose of the drop deck vehicle trailer 202 to a height change in the drop deck vehicle trailer 202. For example, the cargo compartment 208 includes a vertical drop 214, and the first predetermined length is equal to the distance from the nose of the drop deck vehicle trailer 202 to the vertical drop 214. In some implementations, the second predetermined length is equal to the distance from the rear (or loading end) of the drop deck vehicle trailer 202 to a height change in the drop deck vehicle trailer 202. Continuing the example above, the second predetermined length is equal to the distance from the second section of the drop deck vehicle trailer 202 to the vertical drop 214.

The at least two sections of the drop deck vehicle trailer 202 define the cargo compartment 208. For example, the length of the cargo compartment 208 may be equal to the first predetermined length and the second predetermined length. In some implementations, the height of the vertical drop 214 is equal to the height difference between adjacent sections. For example, the height of the vertical drop 214 can be equal to the difference between the first height and the second height. In some implementations, vertical drop 214 is a predetermined distance back from the nose of the drop deck vehicle trailer 202. In some implementations, predetermined distance back from the nose of the drop deck vehicle trailer 202 is equal to the length of the first section 204 (i.e., the first predetermined length). For example, a cargo compartment 208 may be approximately 53 ft. in length and include a vertical drop 214 of 18 in. set 10 ft. from the nose of the trailer. In this example, the first section 204 is approximately 10 ft., the second section 206 is approximately 43 ft. (e.g., 53 ft. minus the 10 ft.), and the difference between the first height and the second height equals 18 in. In some implementations, the predetermined distance from the nose of the drop deck vehicle trailer 202 (i.e. length of the first section 204) can be approximately 10 ft. (+/−1 ft.). In some implementations, the vertical drop 214 is 18 in. (+/−2 to 4 in.).

The vertical drop 214 increases the effective ceiling height in the second section 206 of the of the drop deck vehicle trailer 202, and thereby increases available cubic capacity. The examples provided above increase the total carrying capacity by approximately 500 cubic ft. (a +12.5% improvement) over conventional vehicle trailers 100 (FIG. 1). Additionally or alternatively, in some implementations, the drop deck vehicle trailer 202 includes two solid axles (not shown), suspension (not shown), and low profile tires 216 (at the second section 206). The low profile tires 216 have a smaller diameter than standard tractor trailer tires, which allow for a lower floor height (of second section 206). The lower floor height allows the drop deck vehicle trailer 202 to have greater cubic space for carrying freight. In some implementations, the increased cubic space generated by the vertical drop 214 and/or low profile tires 216 result in the height of the second section 206 (i.e., the trailer floor of the second section 206) being lower that the height of the freight loading dock 106.

The lift mechanism 212 of the drop deck vehicle trailer 202 is configured to adjust for the lower floor height of the drop deck vehicle trailer 202. In particular, the lift mechanism 212 is configured to increase or decrease the height of the drop deck vehicle trailer 202 as needed. For example, the drop deck vehicle trailer 202 is shown backed against the freight loading dock 106 for loading or unloading via the second section 206. As shown, the second height of second section 206 (i.e., the floor of the drop deck vehicle trailer 202) is below the height freight loading dock 106. As discussed below, the lift mechanism 212 can be used to adjust the height of the drop deck vehicle trailer 202 such that the drop deck vehicle trailer 202 is accessible via the freight loading dock 106.

FIG. 2B illustrates a second view 230 of the drop deck vehicle trailer 202, in accordance with some implementations. The second view 230 shows the drop deck vehicle trailer 202 with an adjusted height. More specifically, the height of drop deck vehicle trailer 202 is adjusted, by the lift mechanism 212, to be the same height or approximately the same height as the freight loading dock 106 (i.e., level with the freight loading dock 106). The lift mechanism 212 is configured to increase or decreases the height of the drop deck vehicle trailer 202 to allow for the drop deck vehicle trailer 202 to be loaded or unloaded at freight loading docks 106 of varying heights. Moreover, the lifting mechanisms 212 allows for the drop deck vehicle trailer's 202 lower floor height (of the second section 206) to be raised up to the height of standard US freight docks 106 (or other freight dock 106 heights). In this way, the drop deck vehicle trailer 202 does not have to be loaded or unloaded at non-standard (or customized) docks or by hand.

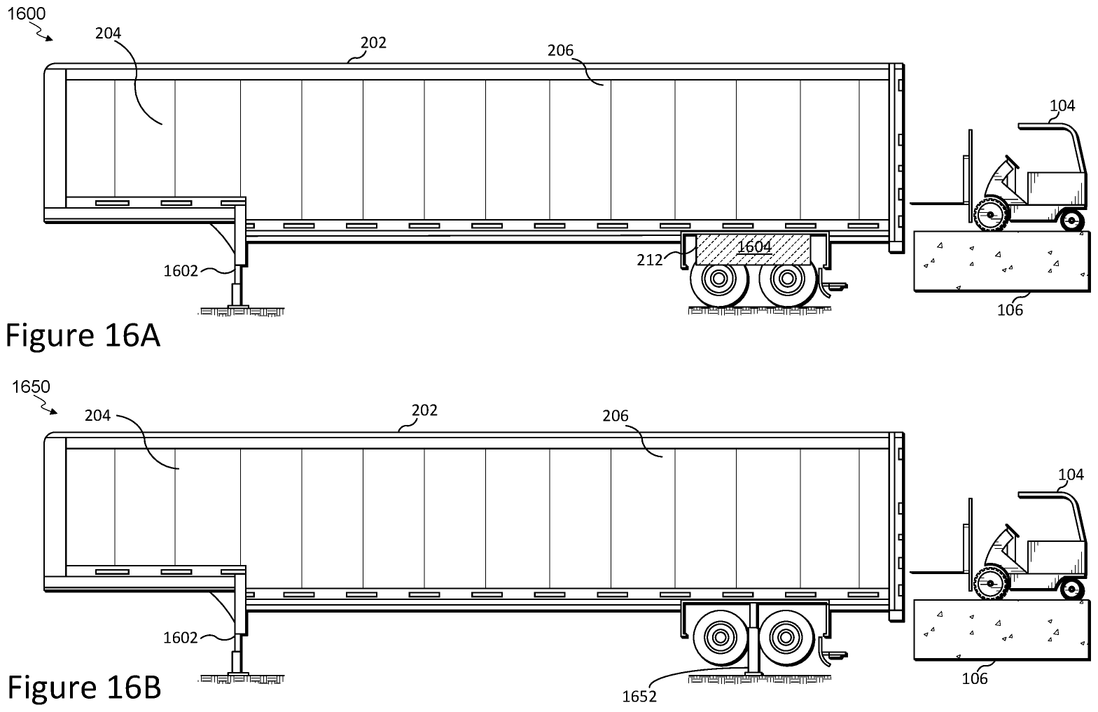

In some implementations, the lift mechanism 212 is an adjustable height suspension and/or an extendable landing gear. In some implementations, the lift mechanism 212 is an air bag lift, hydraulic lift, and/or electro-mechanical lift. In some implementations, the lift mechanism 212 is at a second section 206 of the drop deck vehicle trailer 202. For example, the loading view 250 illustrates the lift mechanism 212 at the second section 206 (i.e., loading end), and increasing the height of the drop deck vehicle trailer's 202 second section 206 to be the same height (or approximately the same height) as the freight loading dock 106, thereby enabling forklift access to the trailer. Alternatively or additionally, in some implementations, the lift mechanism 212 can be at the first section 204. For example, as further shown in the loading view 250, an additional lift mechanism 212 at the first section 204 (e.g., a front landing gear) is raised to elevate the floor of the drop deck vehicle trailer 202 up to the height of the freight dock 106. In some implementations, the lift mechanism 212 at the first section 204 is configured to maintain the trailer floor parallel to the ground and the freight dock 106. The lifting mechanisms 212 is discussed in further detail below in reference to FIGS. 16A and 16B.

The drop deck vehicle trailer 202 is configured to be loaded with loaded pallets 102. In some implementations, the loaded pallets 102 are organized or positioned in one or more rows. In some implementations, a row includes at least two loaded pallets 102 side by side or an oversized loaded pallet 102 (e.g., spanning a width greater than a single loaded pallet 102). Alternatively, in some implementations, a row is a loaded pallet 102 that spans a substantial portion of the cargo compartment 208 width. In some implementations, the substantial portion includes the cargo width minus a safe clearance width (e.g., 6 in. total). The drop deck vehicle trailer 202 can be loaded or unloaded via a forklift 104 or other similar device. The forklift 104 can access the cargo compartment 208 of the drop deck vehicle trailer 202 via the second section 206, and load or unload loaded pallets 102 in any of the at least two section.

In some implementations, the forklift 104 is able to load or unload loaded pallets 102 in the first section 204 of the drop deck vehicle trailer 202 via the adjustable platform 210 located at the first section 204 of the drop deck vehicle trailer 202. In particular, the adjustable platform 210 allows the forklift 104 to load or unload loaded pallets 102 at or near the nose of the drop deck vehicle trailer 202, which would otherwise be inaccessible to the forklift 104 due the vertical drop 214. In some implementations, at least two adjustable platforms 210 are side by side (forming a row), such that each adjustable platform 210 can be loaded independently (or both are loaded simultaneously via a unitizing platform or beam discussed below). Alternatively, in some implementations, a single adjustable platform 210 is configured to support a row of at least two loaded pallets 102. For example, the adjustable platform 210 can be a wide enough to support at least two loaded pallets 102 or the at least two loaded pallets 102 are loaded on the adjustable platform 210 via a unitizing platform or beam.

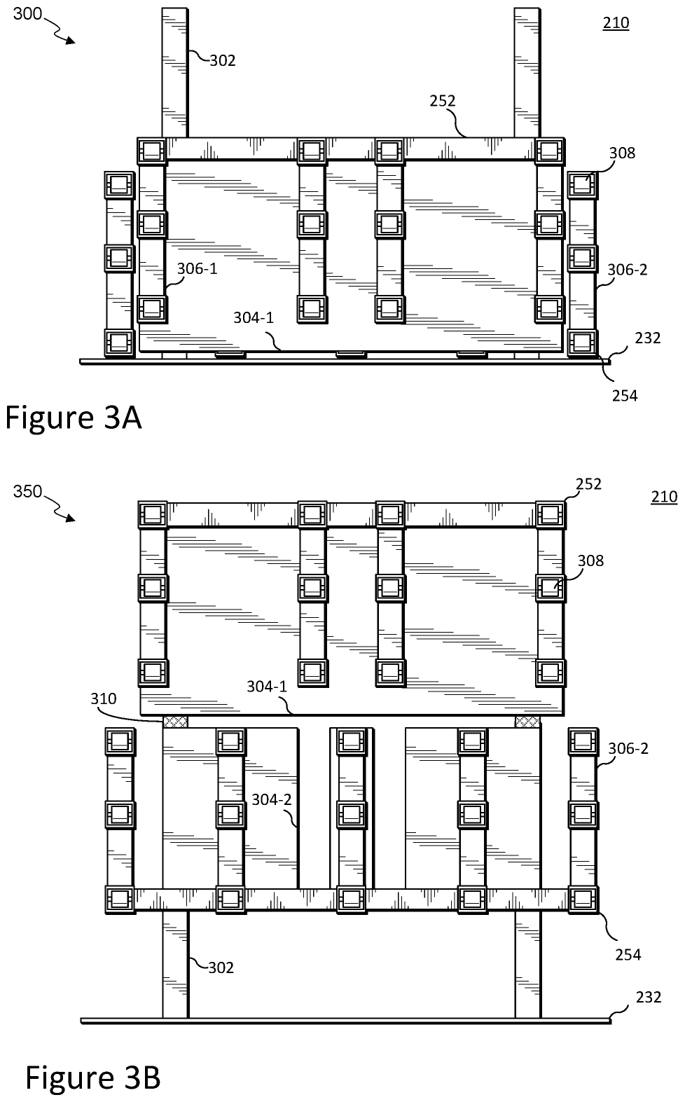

The adjustable platform 210 is configured to move between the nose of the drop deck vehicle trailer 202 and the vertical drop 214 (i.e., the first predetermined length). In this way, the entire first section 204 (or a substantial portion) is accessible to the forklift 104, and can be loaded with loaded pallets 102. In some implementations, the adjustable platform 210 is configured to remain on the first section 204. In particular, in some implementations, the first section 204 of the drop deck vehicle trailer 202 includes a stopper 232 adjacent to or at the vertical drop 214. The stopper 232 is configured to prevent or reduce the risk of loaded pallets 102 and/or the adjustable platform 210 from falling off of the first section 204 (and onto the second section 206) during transportation, or accidently during loading of the drop deck vehicle trailer 202. Similarly, in some implementations, the stopper 232 is configured to prevent or reduce the chances of the adjustable platform 210 being accidently pushed or pulled off from the first section 204. As an example, the adjustable platform 210 may be near the nose of the drop deck vehicle trailer 202, and the forklift 104 may be used to move (e.g., pull) the adjustable platform 210 to the vertical drop 214. The stopper 232 is configured to prevent freight from accidentally sliding off of the first section 204 either as a result of the vibration and/or tilt of moving the drop deck vehicle trailer 202, or as an unintended result of handling with the forklift 104. Alternatively or additionally, in some implementations, the adjustable platform 210 rests on or is coupled to a track system (discussed below in reference to FIGS. 3A and 3B).

FIG. 2C illustrates a third loading view 250 of the drop deck vehicle trailer 202, in accordance with some implementations. In some implementations, the adjustable platform 210 includes an outer platform 252 and an inner platform 254. Both the outer platform 252 and the inner platform 254 are configured to be loaded with loaded pallets 102. For example, the outer platform 252 and the inner platform 254 are each configured to be loaded with a loaded pallet 102 or a row of pallets 102. In some implementations, the outer platform 252 is configured to be loaded first and moved towards the nose section of the drop deck vehicle trailer 202 before the inner platform 254 can be loaded. Alternatively, in some implementations, the inner platform 254 is configured to be loaded first and moved towards the nose section of the drop deck vehicle trailer 202 before the outer platform 252 can be loaded. Both the outer platform 252 and the inner platform 254 are configured to be moved between the nose of the drop deck vehicle trailer 202 and the vertical drop 214. In this way, the first predetermined length of the first section 204 is accessible to the forklift 104, even though the forklift cannot directly access the front of the first section 204 due to the vertical drop which prevents the forklift moving forward of the drop.

FIG. 2D illustrates a fourth loading view 270 of the drop deck vehicle trailer 202, in accordance with some implementations. In some implementations, the first section 204 of the drop deck vehicle trailer 202 is configured to support at least three rows of loaded pallets 102. For example, as shown in the fourth loading view 270, the first section 204 is loaded with a first row of loaded pallets 102 on the outer platform 252, a second row of loaded pallets 102 on the inner platform 254, and a third row of loaded pallets 102 on the floor of the first section 204 (adjacent to the vertical drop 214). The adjustable platform 210 allows for substantially all of the first section 204 to be filled with loaded pallets 102 by allowing for loaded pallets 102 to be organized and positioned as needed.

In some implementations, the adjustable platform 210 can be locked to the first section 204, a track system, or individually locked. When locked, the adjustable platform 210 prevents or minimizes any unwanted movement, or prevents or reduces movement when pushed or pulled. In some implementations, the outer platform 252 and inner platform 254 can be locked individually. In some implementations, locking either the outer platform 252 or the inner platform 254, prevents the other platform from moving. In some implementations, the adjustable platform 210 can be locked at different positions of the first section 204.

In some implementations, the drop deck vehicle trailer 202 includes at least one digital camera system (not shown) and at least one telematics device (not shown). The digital camera system and/or the telematics device are configured to provide data on the loading and unloading operation of the drop deck vehicle trailer 202. In some implementations, the digital camera system and/or the telematics device are configured to capture data corresponding to loaded pallets 102 loaded or unloaded from the drop deck vehicle trailer 202, and/or moved or repositioned within the cargo compartment 208. For example, the digital camera system is configured to capture one or more images as loaded pallets 102 are loaded or unloaded from the drop deck vehicle trailer 202. Alternatively or additionally, in some implementations, the captured data corresponds to handling equipment loaded on or unloaded from the drop deck vehicle trailer 202. In some implementations, the digital camera system and/or the telematics device are used to provide security (e.g., surveillance and/or freight tracking), such as capturing data to confirm that freight was not interfered with in transit, or if there are multiple shipments on a trailer that each shipment was not interfered with.

In some implementations, the digital camera system and/or the telematics device provide the collected data to one or more servers and/or computing devices via a wired or wireless network, such as Ethernet, Bluetooth, Wi-Fi, RFID, etc. The one or more computing devices include personal computers, personal data assistants, mobile devices such as laptops, tablet computers, or smartphones. In some implementations, the data provided by the digital camera system and/or the telematics device allows for the efficient use and management of the drop deck vehicle trailer 202. More specifically, the one or more servers and/or computing devices can use the data to determine the quality of the load (e.g., efficient or inefficient use of the cargo compartment 208), remaining capacity on the drop deck vehicle trailer 202, and provide recommendations on loading the drop deck vehicle trailer 202. The determined information is provided, by the one or more servers and/or computing devices, to a user associated with the one or more servers and/or computing devices. The user, for purposes for this disclosure, is a shipper and/or carrier of goods.

In some implementations, the one or more servers and/or computing devices use the data to generate instructions (or a plan) for loading and unloading the drop deck vehicle trailer 202 (e.g., instructions for positioning, organizing, moving, stacking, storing, etc. the loaded pallets 102). Additionally or alternatively, in some implementations, the one or more servers and/or computing devices can receive transportation data from the user to generate instructions for loading and unloading the drop deck vehicle trailer 202. In some implementations, the transportation data includes the type of goods to be transported, the quantity of goods, the size and/or dimensions of goods, and/or other information corresponding to the goods to be loaded in the drop deck vehicle trailer 202. The generated instructions include a instructions for loading or unloading loaded pallets 102 into the drop deck vehicle trailer 202 to improve utilization. In some implementations, the one or more servers and/or computing devices provide the generated instructions to a user associated with the one or more servers and/or computing devices.

In some embodiments, the transportation data includes data for more than one shipment. Each shipment can consists of one or more handling units (e.g., a loose boxes or loaded pallets 102). In some implementations, the one or more servers and/or computing devices use the transportation data to assign the shipments to the drop deck vehicle trailer 202. More specifically, the one or more servers and/or computing devices can determine the placement of different shipments in one or more drop deck vehicle trailers 202 to efficiently transport the shipments. In some implementations, the one or more servers and/or computing devices utilize optimization techniques, machine learning models, or other algorithms to assign the shipments to the drop deck vehicle trailer 202. The shipment assignments minimize the cost to transport the shipments within the service commitments and transit times committed to the shipper.

In some implementations, the one or more servers and/or computing devices determine a pickup and drop off sequence for each shipment assigned to a drop deck vehicle trailer 202. The pickup and drop off sequence includes instruction identifying an order for picking up each shipment as well as an order for dropping off each shipment. For example, a drop deck vehicle trailer 202 assigned three shipments may be provided a pickup and drop off sequence instructing the drop deck vehicle trailer 202 to pick up a third shipment before a first shipment and picking up a second shipment after the first shipment, and the pickup and drop off sequence may further instruct the drop deck vehicle trailer 202 to drop off the first shipment before the second shipment and drop off the third shipment last. In some implementations, the pickup and drop off sequence includes instruction for loading and unloading the drop deck vehicle trailer 202 (as described above). The pickup and drop off sequence minimizes the amount of time spent loading or unloading loaded pallets 102 as well as the total amount of time spent handling loaded pallets 102 each time a shipment is delivered.

FIGS. 3A and 3B illustrate top views of an adjustable platform, in accordance with some implementations. A first top view 300 of the adjustable platform 210 includes an outer platform 252, inner platform 254, and track system 302. In some implementations, the outer platform 252 and the inner platform 254 are configured to nest or rest inside one another. For example, the outer platform 252 is configured to fit on top or house the inner platform 254. Similarly, the inner platform 254 is configured to fit underneath or inside of the outer platform 252. In some implementations, the outer platform 252 and the inner platform 254 can be locked together (without locking movement of the adjustable platform 210). In particular, in some implementations, the outer platform 252 and the inner platform 254 can be connected and secured to each other in a nested configuration. In some implementations, the outer platform 252 and the inner platform 254 can operate as a single platform when nested. For example, the outer platform 252 and the inner platform 254 can be loaded, unloaded, or moved as one when nested.

In some implementations, the outer platform 252 includes a first loading surface 304-1 (e.g., a deck) coupled to one or more first support members 306-1. The first loading surface 304-1 is configured to support one or more loaded pallets 102 loaded on the outer platform 252. Similarly, in some implementations, the inner platform 254 includes a second loading surface 304-2 coupled to one or more second support members 306-2. In some implementations, the second loading surface 306-2 is divided into at least two portions. The second loading surface 306 is configured to support one or more loaded pallets 102 loaded on the inner platform 254. In some implementations, the first loading surface 304 is over the second loading surface 306. Alternatively, in some implementation, the second loading surface 306 is over the first loading surface 304. The one or more support beams 306 of the outer platform 252 and the inner platform 254 each include one or more components 308 configured to allow the outer platform 252 and/or the inner platform 254 to move between the nose of the drop deck vehicle trailer 202 and the vertical drop 214 (i.e., forward and/or backwards along the first predetermined length of the first section 204). In some implementations, the one or more components 308 include slide mechanisms, wheels, rollers, gears, or other similar components.

The track system 302 may include grooves, rails, depressions, sliders, trenches, channels, and/or other tracks. In some implementations, the track system 302 includes one or more adjustable connectors 310. The one or more adjustable connectors 310 extend from the nose of the drop deck vehicle trailer 202 to the vertical drop 214. In some implementations, the one or more adjustable connectors 310 are configured to extend or contract with fasteners, ratchet mechanisms or other similar mechanisms. In particular, in some implementations, the track system 302 can be set to different lengths as needed. In some implementations, the one or more adjustable connectors 310 are secured to the drop deck vehicle trailer 202 with fasteners, a ratchet and/or lock. In some implementations, the track system 302 is recessed within the drop deck vehicle trailer 202 to maintain a flat surface (i.e. the track system 302 does not protrude over the surface of the first section 204).

In some implementations, the adjustable platform 210 rests on or is coupled to the track system 302. For example, in some implementations, the track system 302 includes one or more rails and the adjustable platform 210 includes one or more wheels resting on the rails or sliders coupled to the rails. In another example, the track system 302 includes one or more depressions and the adjustable platform 210 includes one or more wheels residing or resting in the depressions. In some implementations, the movement of the adjustable platform 210 is dependent on the length of the track system 302. For example, if the track system 302 extends to half of the first predetermined length of the first section 204, then the adjustable platform's 210 movement may be restricted to the length of the track system 302 (i.e., half of the first predetermined length). In some implementations, the track system 302 secures the adjustable platform 210 to the first section 204 such that the adjustable platform 210 cannot accidently be pulled off the first section 204 (e.g., by a forklift). In some implementations, the track system 302 prevents the adjustable platform 210 from moving in random directions (i.e., constraining the adjustable platform's 210 movements to the tracks). In some implementations, the track system 302 includes a stopper 232 as described above in reference to FIGS. 2A-2D.

A second top view 350 illustrates the outer platform 252 and the inner platform 254 when not nested. In particular, the second top view 350 shows the outer platform 252 separated from the inner platform 254. The outer platform 252 and the inner platform 254 are configured to move independently or together. Similarly, the outer platform 252 and the inner platform 254 can be loaded or unloaded independently or together. The outer platform 252 and the inner platform 254 each move along the track system 302. In some implementations, the outer platform 252 and the inner platform 254 are configured to remain in proximity to one in another. For example, in some implementations, once the outer platform 252 is moved a predetermined distance away from the inner platform 254, the outer platform 252 will pull on the inner platform 254, and vice versa. Continuing the example, if the inner platform 254 were locked to the track system 302, the inner platform 254 would act as an anchor or lock to the outer platform 252. In some implementations, the predetermined distance is at least the distance to such that the inner platform 254 and the outer platform 252 are no longer nested. (i.e., the length 352 of the outer platform 252 or the length 354 of the inner platform 254).

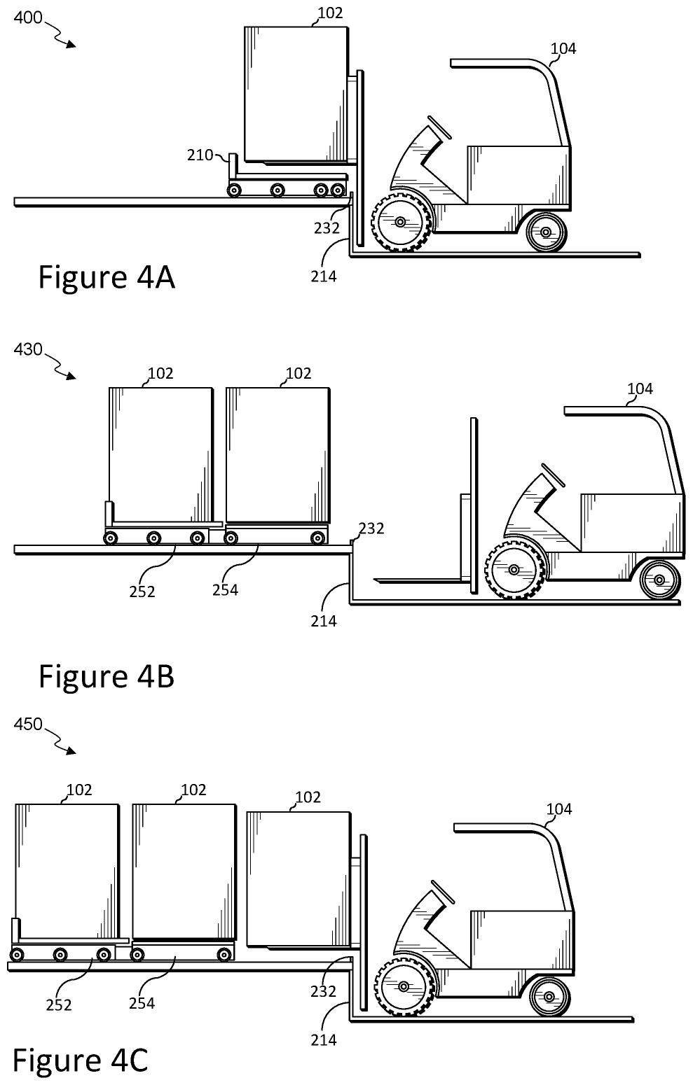

FIGS. 4A-4C illustrate side views of an adjustable platform, in accordance with some implementations. A first side view 400 shows an adjustable platform 210 including an outer platform 252 and an inner platform 254 in a nested configuration. In some implementations, a forklift 104 (FIGS. 2A-2D) accesses the first section 204 via the adjustable platform 210. In particular, the forklift 104 uses the adjustable platform 210 to load or unload loaded pallets on the first section 204 of the drop deck vehicle trailer 202, which would normally be inaccessible to the forklift 104 due to a vertical drop 214 (FIGS. 2A-2D). For example, in the first side view 400, the forklift 104 loads a loaded pallet 102 on the adjustable platform 210 at an edge of the first section 204 (e.g., adjacent to the vertical drop 214). By utilizing the adjustable platform 210, the forklift 104 is able to load or unload loaded pallets 102 in the first section 204 without directly accessing the first section 204.

In some implementations, the loaded pallet 102 can be loaded directly on the adjustable platform 210 (i.e., a nested configuration). In some implementations, the loaded pallet 102 is loaded on a first loading surface 304 (FIGS. 3A and 3B) of the outer platform 252 or a second loading surface 306 (FIGS. 3A and 3B) of the inner platform 254. For example, in some implementations, the first loading surface 304 envelops the second loading surface 306, and, as such, the first loading surface 304 is loaded with at least one loaded pallet 102 before the second loading surface 306. Alternatively, in some implementations, the second loading surface 306 envelops the first loading surface 304, and is loaded with at least one loaded pallet 102 before the first loading surface 304.

FIG. 4B shows a second side view 430 shows the outer platform 252 and the inner platform 254 in a separated configuration. More specifically, the outer platform 252 and the inner platform 254 are no longer nested, and each are loaded with one or more loaded pallets 102. In some implementations, the outer platform 252 is loaded first and moved (towards the nose of the drop deck vehicle trailer 202) before the inner platform 254 can be loaded. Alternatively, in some implementations, the inner platform 254 is loaded first and moved (towards the nose of the drop deck vehicle trailer 202) before the outer platform 252 can be loaded. In some implementations, the outer platform 252 and the inner platform 254 are moved backward via the forklift 104. For example, the forklift 104 may load the outer platform 252 with one or more loaded pallets 102 and push the outer platform 252 (towards the nose of the drop deck vehicle trailer 202) before loading additional loaded pallets 102 on the inner platform 254.

In some implementations, the outer platform 252 and the inner platform 254 are linked or connected (e.g., via connector 432) such that the outer platform 252 and the inner platform 254 remain proximate to or near one another. For example, continuing the example above, when the forklift 104 moves the outer platform 252 towards the nose of the drop deck vehicle trailer 202, the outer platform 252 will drag or pull the inner platform 254 such that they remain adjacent to one another. In some implementations, the connection or link can be locked such that the outer platform 252 and the inner platform 254 remain apart a predetermined distance. In some implementations the predetermined distance that the platforms are to remain part is set by the user.

FIG. 4C shows a third side view 450 which illustrates a third row of loaded pallets 102 placed on the first section 204. The adjustable platform 210 allows the forklift 104 to load the additional cubic space generated by the drop deck vehicle trailer 202. More specifically, the forklift 104 can load loaded pallets 102 102 on the outer platform 252 and the inner platform 254, and move the outer platform 252 and the inner platform 254 towards the nose of the drop deck vehicle trailer 202 to generate free space on the first section 204 to load an additional row of loaded pallets 102. The forklift 104 may move the adjustable platform 210 using one or more projected blades of the forklift 104 (i.e., using the projected blades to push the outer platform 252 and/or the inner platform 254). In some implementations, the outer platform 252 and the inner platform 254 are moved via hydraulic, electrical, or mechanical motors. In some implementation, the outer platform 252 and the inner platform 254 are moved without substantial force (i.e., moveable by a single person).

Alternatively or additionally, ins some implementations, the forklift 104 can be used to pull the adjustable platform 210 towards the vertical drop 214. For example, a cable and/or hook can be attached to the forklift 104 and coupled to the adjustable platform 210 such that the forklift 104 pulls the adjustable platform 210 as the forklift 104 backs up (towards a loading end). In some implementations, to prevent the forklift 104 from pulling the adjustable platform 210 too far back, the cable and/or hook include magnets or similar devices that are configured separate or come apart when there is too much resistance (i.e., provide a fixed stop and prevent the adjustable platform 210 from being pulled off of the vertical drop 214 or first section 204). Alternatively or additionally, in some implementations, the track system 302 includes a fixed stop (e.g. stopper 232) adjacent to the vertical drop 214, or the vertical drop 214 includes the fixed stop.

Although the examples above describe the use of a forklift 104 to move the adjustable platform 210, any variety of mechanism can be used to move the adjustable platform 210. For example, the adjustable platform 210 may include one or more components 308 (FIGS. 3A and 3B), such as sliders, rollers, wheels, and/or tracks that allow a person to move the adjustable platform 210. In this way, the adjustable platform 210 can be easily moved without substantial force. Substantial force, for purposes of this disclosure, is a force greater than the force applied by a single person.

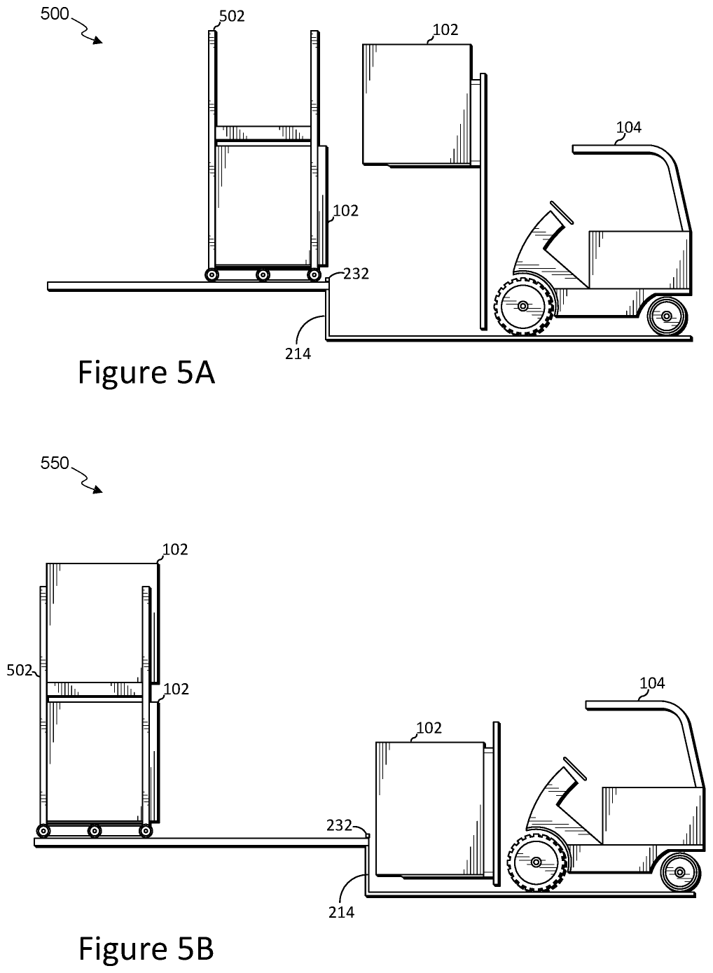

FIGS. 5A and 5B illustrate different views of the adjustable platform 210 loaded with a pallet rack, in accordance with some implementations. A first pallet rack loading view 500 shows the adjustable platform 210 being loaded with a pallet rack 502. The pallet rack 502 is configured to receive one or more loaded pallets 102. In some implementations, the pallet rack 502 includes one or more shelves 504, and each shelf 504 configured to be loaded with one or more loaded pallets 102. The one or more shelves 504 are configured to separate the loaded pallets 102 such that the loaded pallets 102 does not rest on one another. In some implementations, the adjustable platform 210 is loaded with the pallet rack 502 fully loaded. Alternatively or additionally, in some implementations, the adjustable platform 210 is loaded with the an empty pallet rack 502, and the empty pallet rack 502 is subsequently loaded with one or more loaded pallets 102 while on the adjustable platform 210.

A second pallet rack loading view 550 shows the adjustable platform 210 moved towards the nose of the drop deck vehicle trailer 202. By moving the adjustable platform 210 towards the nose of the drop deck vehicle trailer 202, additional space is generated to load additional freight on the first section 204. As mentioned above, in some implementations, the adjustable platform 210 includes an outer platform and an inner platform (not shown). Both the outer platform and the inner platform can each be loaded with a pallet rack 502. Further information on the pallet rack is contained in U.S. patent application Ser. No. 16/817,270, which is incorporated herein by reference in its entirety.

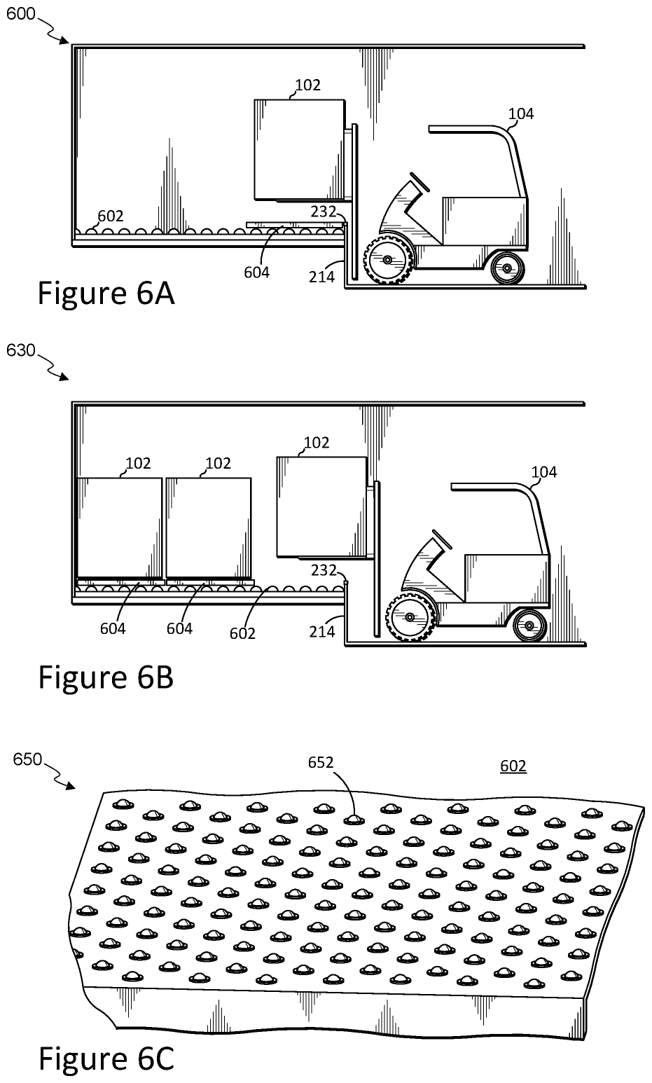

FIGS. 6A-6C illustrate different views of a conveyor or roller mechanism, in accordance with some implementations. A first view 600 includes the conveyor mechanism 602, a forklift 104, one or more loaded pallets 102, and a first section 204 of the drop deck vehicle trailer 202. In some implementations, the conveyor mechanism is used instead of an adjustable platform 210. Alternatively, in some implementations, the conveyor mechanism is used in conjunction with the adjustable platform 210. In some implementations, the first section 204 of the drop deck vehicle trailer 202 includes the conveyor mechanism 602. In some implementations, the conveyor mechanism 602 includes ball matt flooring. The conveyor mechanism 602 extends a portion or the entire length of the first section 204 floor (i.e., the first predetermined length). The conveyor mechanism 602 is configured to support one or more loaded pallets 102, and allow the one or more pallets 102 to be moved (along the first predetermined length) without substantial force. For example, a loaded pallet 102 on the conveyor mechanism 602 can be moved by a single person pushing or puling on the loaded pallet 102. Although not shown, adjustable platform 210, a pallet rack 502, or any other freight can be loaded on the conveyor mechanism 602.

The conveyor mechanism 602 can be loaded via the forklift 104 and/or any other similar device. The forklift 104 is able to load or unload loaded pallets 102 in the first section 204 without directly accessing the first section 204.

A second view 630 of the conveyor mechanism 602 shows the loading of the conveyor mechanism 602. As shown in the second view 630, the forklift 104 places at least three loaded pallet 102 directly on the conveyor mechanism 602. In some implementations, a planar surface 604 is placed between the conveyor mechanism 602 and the loaded pallets 102. In some implementations, the planar surface 604 is configured to further reduce the friction between the conveyor mechanism 602 and the loaded pallet 102. Alternatively or additionally, in some implementations, the planar surface 604 is configured to provide an even surface between the first conveyor mechanism 602 and the loaded pallet 102 such that it is easier to move without substantial force. In some implementations, the first section 204 of the drop deck vehicle trailer 202 includes a stopper 232 (described above in reference to FIGS. 2A-2D) adjacent to the vertical drop 214. In this way, one or more a loaded pallets are not able to fall off of the first section 204 during transportation, or accidently during loading of the drop deck vehicle trailer 202.

A third view 650 illustrates a perspective view of the conveyor mechanism 602. In some implementations, the conveyor mechanism 602 is a ball mat flooring. The ball mat flooring includes a plurality of balls 652. In some implementations, the plurality of balls 652 is integrated with the trailer floor. Alternatively, in some implementations, the plurality of balls 652 is adjustable components that can be moved or adjusted on the trailer floor.

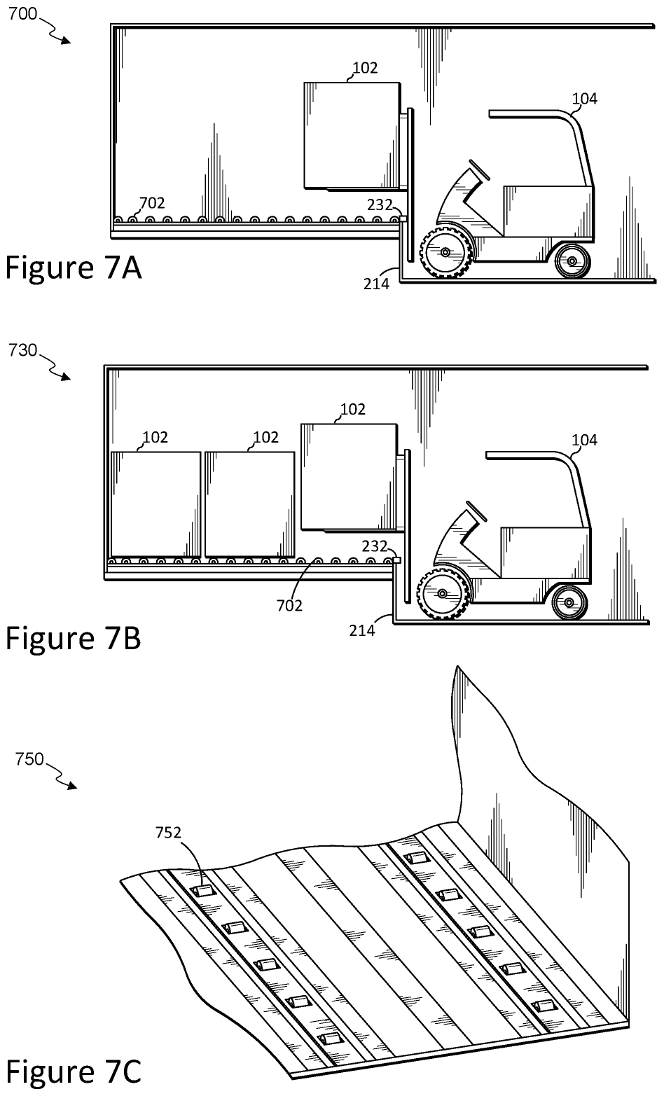

FIGS. 7A-7C illustrate different views of an alternate conveyor mechanism, in accordance with some implementations. A first view 700 of the alternate conveyor mechanism 702 includes all of the features described above with respect to FIGS. 6A and 6B. For example, the first section 204 of the drop deck vehicle trailer 202 includes the alternate conveyor mechanism 702 that extends a portion or the entire length of the first predetermined length of the first section 204. The alternate conveyor mechanism 702 includes a plurality of rollers. In some implementations, the alternate conveyor mechanism 702 is configured to support one or more loaded pallets 102, and allow the one or more pallets 102 to be moved without substantial force.

A second view 730 of the alternate conveyor mechanism 702, shows the forklift 104 placing at least three loaded pallet 102 directly on the alternate conveyor mechanism 702. The alternate conveyor mechanism 702 allows for additional flexibility when moving loaded pallets 102 placed thereon. In particular, the alternate conveyor mechanism 702 is able to accommodate different shaped loaded pallets 102 (e.g., loaded pallets without flat bases or surfaces). Further, the alternate conveyor mechanism 702 can use the planar surface 604 described above in reference to FIGS. 6A and 6B. In some implementations, the first section 204 of the drop deck vehicle trailer 202 includes a stopper 232 as described above in reference to FIGS. 2A-2D.

A third view 750 illustrates a perspective view of the alternate conveyor mechanism 702. In some implementations, the alternate conveyor mechanism 702 is a plurality of rollers 752. In some implementations, the plurality of rollers 752 is integrated with the trailer floor. Alternatively, in some implementations, the plurality of rollers 752 is adjustable components that can be moved or adjusted on the trailer floor.

Although the examples provided above describe a ball mat and/or rollers, in some implementations, the conveyor mechanism can be any other electrical or mechanical system that is configured to move the one or more pallets 102 or other freight loaded thereon. Further, in some implementations, the conveyor mechanism can be operated by one or more computer programs.

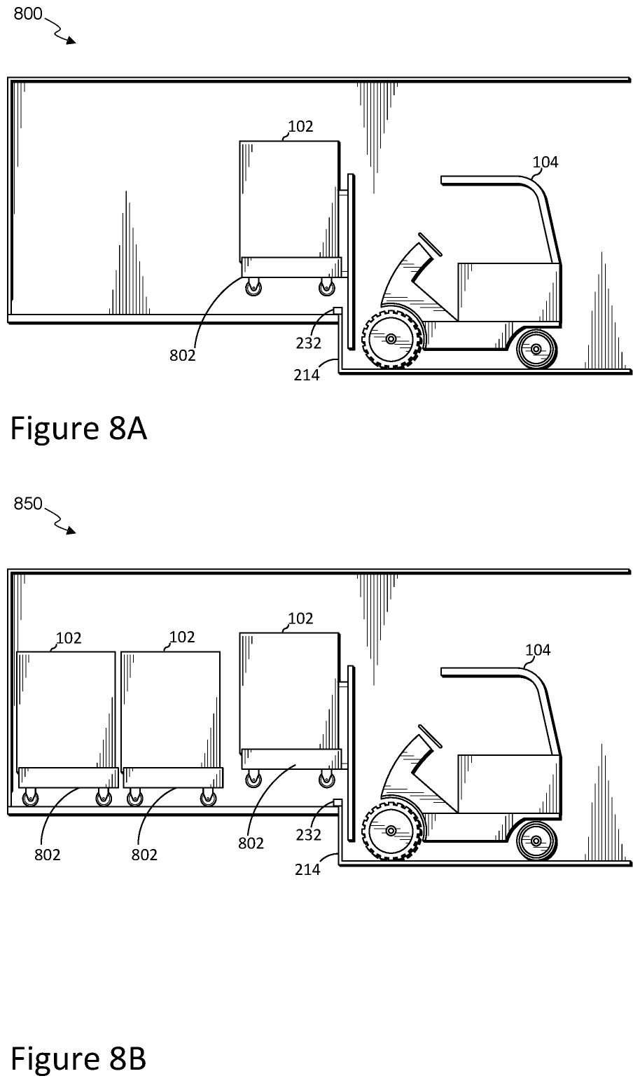

FIGS. 8A and 8B illustrate an alternate method of loading a first section of the drop deck vehicle trailer. A first view 800 of the alternate loading method includes a moveable base 802, a forklift 104, one or more loaded pallets 102, and a first section 204 of the drop deck vehicle trailer 202. In some implementations, one or more pallets 102 are placed on the moveable base 802 via the forklift 104 or similar device. In some implementations, the moveable base 802 is configured to be forklifted (via the forklift 104) onto the first section 204. In this way, the forklift 104 is able to access the first section 204 indirectly (i.e., without driving on the first section 204). In some implementations, the moveable base 802 is loaded before being placed on the first section 204. Alternatively, in some implementations, the moveable base 802 is loaded after being placed on the first section 204. The moveable base 802 is configured to roll or slide along the first section 204. The moveable base 802 is configured to be moved without substantial force while loaded or unloaded. In this way, the moveable base 802 can be placed on the first section 204, and moved by a single person.

A second view 850 of the alternate method shows the forklift 104 placing at least three a movable bases 802 (including loaded pallets 102) on the first section 204. Similar to the adjustable platform 210 described above in FIGS. 2A-5B, the movable bases 802 is configured to be moved towards the nose of the drop deck vehicle trailer 202 to generate additional space for loaded pallets 102. In this way, the forklift 104 or similar device is able to fully use the additional space generated by the first section 204. In some implementations, the first section 204 of the drop deck vehicle trailer 202 includes a stopper 232 as described above in reference to FIGS. 2A-2D.

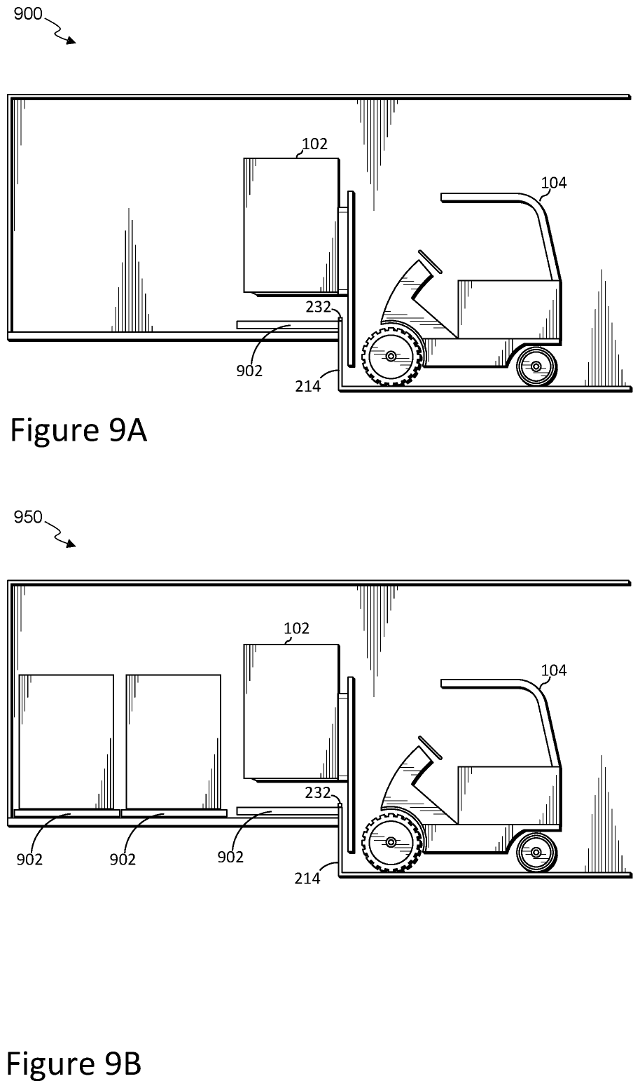

FIGS. 9A and 9B illustrate another alternative method of loading the first section. A first view 900 of the other alternate method of loading the first section 204 of the drop deck vehicle trailer 202 includes a low friction surface 902, a forklift 104, one or more loaded pallets 102, and a first section 204 of the drop deck vehicle trailer 202. In some implementations, the surface of the first section 204 includes a low friction material. The low friction material of the first section 204 is configured to allow one or more pallets 102 to be pushed and pulled without substantial force.

The low friction surface 902 is configured to allow the one or more loaded pallets 102 to be pushed or pulled without substantial force. For example, a loaded pallet 102 on the low friction surface 902 can be moved or slid between the nose of the drop deck vehicle trailer 202 and the vertical drop 214. (i.e., the first predetermined length) without substantial force. In some implementations, the low friction surface 902 is positioned on the first section 204 and the loaded pallet 102 is placed on the low friction surface 902 via the forklift 104. Alternatively, in some implementations, the low friction surface 902 is coupled to the bottom of the loaded pallet 102, which makes the loaded pallet 102 easier to move when placed on the trailer floor. In some implementations, the low friction surface 902 includes an inverted carpet, a sliding base, or other material with a low coefficient of friction. The low friction surface 902 is configured to allow the one or more pallets 102 to be pushed and pulled without substantial force.

A second view 950 of the other alternate method of loading the first section 204 shows the forklift 104 placing at least three pallets 102 on a low friction surface 902. Similar to the adjustable platform 210 described above in FIGS. 2A-5B, the low friction surface 902 is configured to allow the at least three loaded pallets 102 on the first section 204 be moved towards the nose of the drop deck vehicle trailer 202 to generate additional space for loaded pallets 102. In this way, the forklift 104 or similar device is able to fully use the additional space generated by the first section 204. In some implementations, the first section 204 of the drop deck vehicle trailer 202 includes a stopper 232 as described above in reference to FIGS. 2A-2D.

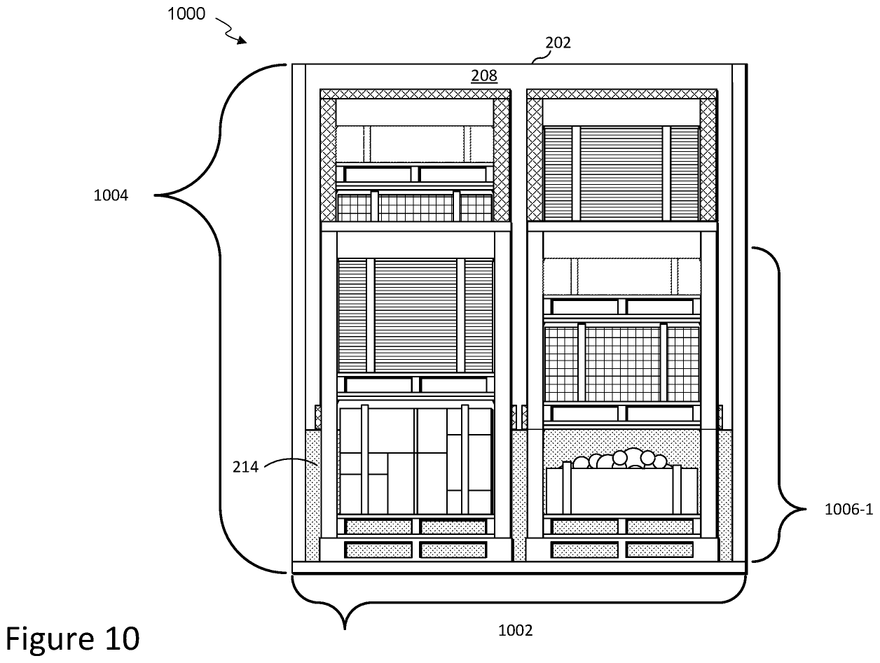

FIG. 10 illustrates a rear view of a loaded drop deck vehicle trailer, in accordance with some implementations. The rear view 1000 shows a view of the drop deck vehicle trailer 202 from a freight loading dock 106 (FIGS. 2A-2D). The drop deck vehicle trailer 202 cargo compartment 208 has a cargo width 1002 and a cargo height 1004. In some implementations, the drop deck vehicle trailer 202 is loaded with one or more rows of loaded pallets 102 (referred to as rows of pallets 1006). As described above, a row of pallets 1006 includes at least two adjacent loaded pallets 102 or an oversized loaded pallet 102 (e.g., spanning a width greater than a single loaded pallet 102). The one or more rows of pallets 1006 are loaded or unloaded in the drop deck vehicle trailer 202 via a forklift 104 (or as otherwise described herein). The rear view 1000 further shows a vertical drop 214 (FIGS. 2A-2D), and at least one additional row of pallets 1006 loaded on the first section 204 of the drop deck vehicle trailer 202.

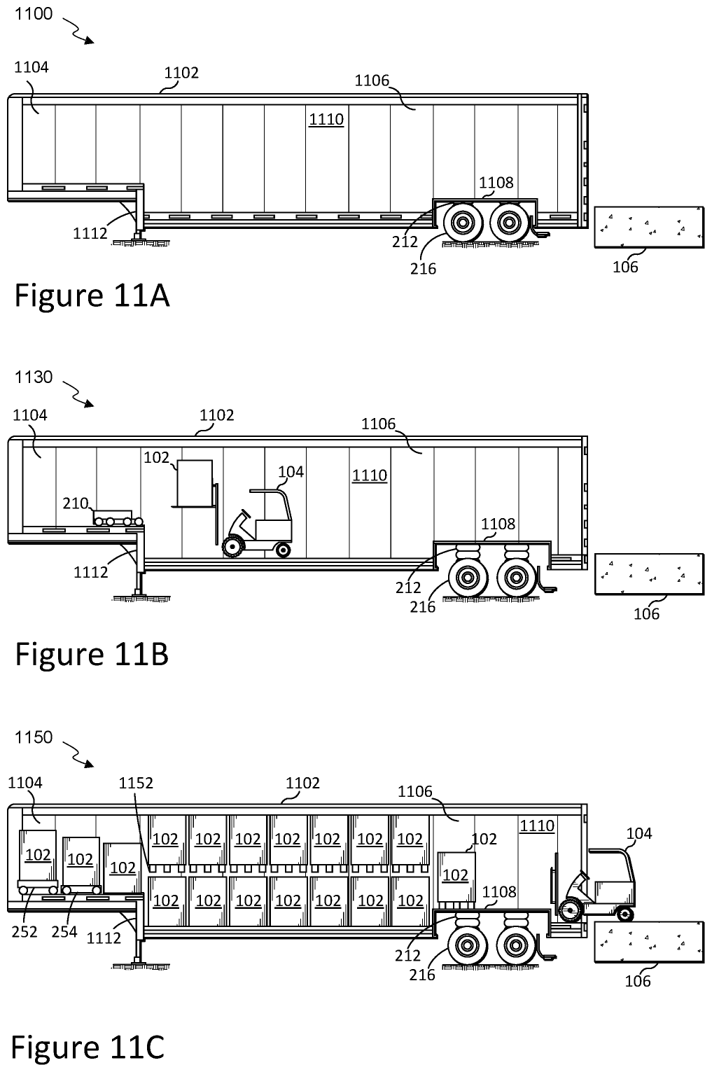

FIGS. 11A-11C are different views of a deep drop deck vehicle trailer, in accordance with some implementations. A first view 1100 includes a deep drop deck vehicle trailer 1102. The deep drop deck vehicle trailer 1102 includes all of the features described above with respect to the drop deck vehicle trailer 202. For example, the deep drop deck vehicle trailer 1102 has a trailer floor including a first section 1104 and a second section 1106 similar to the first section 204 and the second section 206 of the drop deck vehicle trailer 202, respectively. In some implementations, the deep drop deck vehicle trailer 1102 has a floor height that is lower than the drop deck vehicle trailer 202. In particular, the second section 1106 of the deep drop deck vehicle trailer 1102 has a floor height lower than the top of the tires and suspension of the deep drop deck vehicle trailer 1102. In some implementations, the second section 1106 of the deep drop deck vehicle trailer 1102 includes at least two wheel wells 1108. The at least two wheel wells 1108 occupy at least a portion of the deep drop deck vehicle trailer 1102 and enclose a portion of the suspension and top of the tires of the deep drop deck vehicle trailer 1102. The wheel wells 1108 separate the suspension and top of the tires from the a cargo compartment 1110 of the deep drop deck vehicle trailer 1102. In some implementations, the deep drop deck vehicle trailer 1102 utilizes a single wide tire (on either side of at least the second section 1106). In some implementations, use of the single wide tire reduces the overall space occupied by the at least two wheel wells 1108 and makes the at least two wheel wells 1108 narrower. In some implementations, narrower wheel wells 1108 increase the distance between the wheel wells 1108 such that a forklift 104 can between the wheel wells 1108 and access the entire cargo compartment 1110

In some implementations, the first section 1104 includes a first height and the second section 1106 includes a second height. The first height of the first section 1104 is the similar to the height of the first section 204 of the drop deck vehicle trailer 202. The second height of the second section 1106 is lower than the height of the second section 206 of the drop deck vehicle trailer 202. In some implementations, the second height of the second section 1106 is lower than a height of the top of the at least two wheel wells 1108. In some implementations, the deep drop deck vehicle trailer 1102 includes a predetermined vertical drop 1112. In some implementations, the predetermined vertical drop 1112 is at least 20 in. (+/−2 to 4 in.). Similar to the description of FIGS. 2A-2D, the predetermined vertical drop 1112 is equal to the difference between the first height of the first section 1104 and the second height of the second section 1106. The predetermined vertical drop 1112 increases the effective ceiling height in the second section 1106 of the of the deep drop deck vehicle trailer 1102 over the drop deck vehicle trailer 202, and thereby further increasing available cubic capacity. Additionally, in some implementations, the deep drop deck vehicle trailer 1102 includes low profile tires 1114 (in the second section 1106) as described above.

As further shown in first view 1100, the deep drop deck vehicle trailer 1102 can have a floor height (at the second section 1106) lower than the height of a freight dock 106. In some implementations, the deep drop deck vehicle trailer 1102 utilizes a lift mechanism 212 to adjust its floor height to be level with (or the same height as) freight dock 106.

FIG. 11B shows a second view 1130 further shows a forklift 104 carrying a loaded pallet 102 loading the deep drop deck vehicle trailer 1102. In particular, the second view 1130 shows the height of the deep drop deck vehicle trailer 1102 adjusted such that it is equal to the height of the freight dock 106. The adjusted height of the deep drop deck vehicle trailer 1102 allows the forklift 104 to access (i.e., enter) the cargo compartment 1110 of the deep drop deck vehicle trailer 1102 via the freight dock 106.

In some implementations, the at least two wheel wells 1108 are separated by a width of the forklift 104. In this way, the forklift 104 is able to fit in between the at least two wheel wells 1108 and access the entire second section 1106 (e.g., area past the at least two wheel wells 1108). In some implementations, the forklift 104 loads the first section 1104 and the second section 1106 as described above with respect to FIGS. 2A-10.

FIG. 11C shows a third view 1150 shows a fully loaded deep drop deck vehicle trailer 1102. The third view 1150 includes the deep drop deck vehicle trailer 1102, one or more adjustable platforms 210, one or more loaded pallets 102, the at least two wheel wells 1108, and one or more adjustable support members 1152. The one or more adjustable platforms 210 are located on the first section 1104 of the deep drop deck vehicle trailer 1102, and loaded as described above in FIGS. 2A-10.

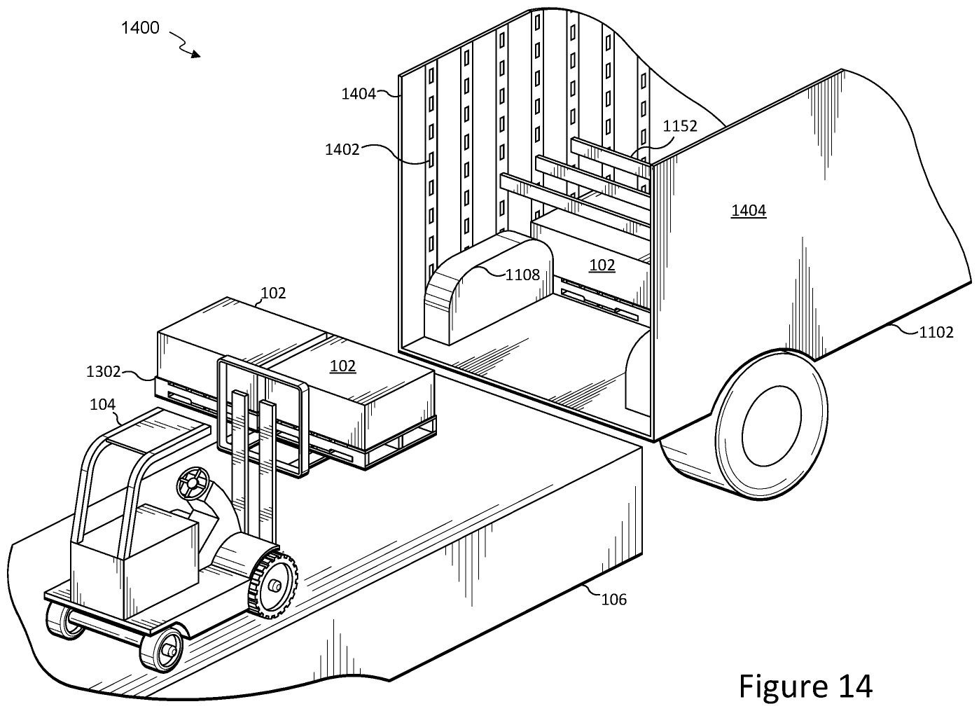

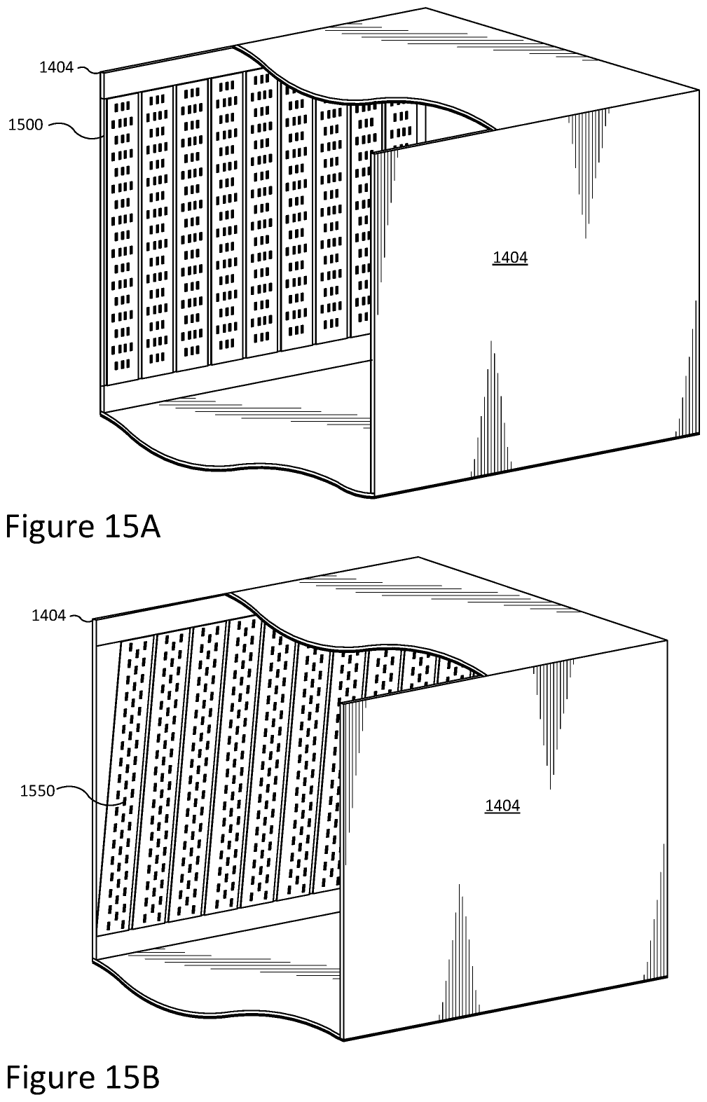

In some implementations, the one or more adjustable support members 1152 are configured to support one or more loaded pallets 102. The adjustable support members 1152 are coupled to a plurality of supports on opposite walls. The plural of supports are discussed below with reference to FIGS. 14-15B. In some implementations, the adjustable support members 1152, as described herein, are removable load bars or posts that attach, clip, or couple to the plurality of supports. Alternatively in some implementations, the adjustable support members 1152 are bars that slide up and down the plurality of supports and/or walls. In some implementations, a flat surface (e.g., decking or plywood) is placed on the adjustable support members 1152 to create a solid platform. In some implementations, the adjustable support members 1152 are collapsible such that they can be stowed when not in use. In some implementations, the adjustable support members 1152 are extendable such that they can couple to supports on different positions on the opposite walls as discussed below. Alternatively, in some implementations, the adjustable support members 1152 are straps or beams configured to secure loaded pallets 102, adjustable platforms 210, and other freight described herein.

In some implementations, the adjustable support members 1152 can be configured at different heights within the cargo compartment 1110. For example, as shown in the third view 1150, the adjustable support members 1152 can be positioned to support a second loaded pallet 102-2 over a first loaded pallet 102-1 in the cargo compartment 10. The adjustable support members 1152 are configured to support loaded pallets 102 over other loaded pallets 102 without resting on or adding additional weight to the lower loaded pallets 102. In some implementations, the adjustable support members 1152 can be positioned such that at least two loaded pallets 102 rest over a loaded pallet 102 on the trailer floor (without the pallets resting on one another). Alternatively or additionally, in some implementations, the adjustable support members 1152 are positioned to secure one or more loaded pallets. The adjustable support members 1152 allow for better use of the upper section of the deep drop deck vehicle trailer 1102 by enabling loaded pallets 102 to safely and efficiently support loaded pallets 102 over the trailer floor. Although the adjustable support members 1152 and the plurality of supports are described in reference to the deep drop deck vehicle trailer 1102, these features can also be included in the drop deck vehicle trailer 202.

In some implementations, the at least two wheel wells 1108 of the deep drop deck vehicle trailer 1102 are configured to support one or more loaded pallets 102. In some implementations, the one or more adjustable support members 1152 can be placed on the at least two wheel wells 1108 and used to support one or more loaded pallets 102. In this way, the adjustable support members 1152 act as a unitizing platform or beam.

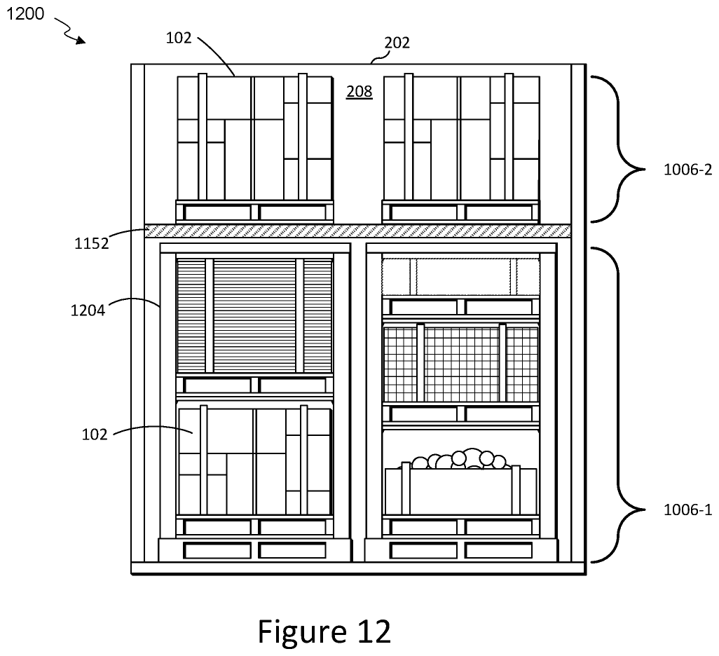

FIG. 12 illustrates a rear view of a loaded drop deck vehicle trailer 202, in accordance with some implementations. The rear view 1200 shows a view of the drop deck vehicle trailer 202 from a freight loading dock 106 (FIGS. 2A-2D). The rear view 1200 is analogous to the rear view 1000 described above in FIG. 10.

The rear view 1200 further illustrates the drop deck vehicle trailer 202 with an adjustable support member 1152. The adjustable support member 1152 supports a first row of pallets 1006-1 over at least a second row pallets 1006-2 resting on the trailer floor. The first row of pallets 1006-1 rests on the adjustable support member 1152 without putting any additional force on the at least second row pallets 1006-2 resting on the trailer floor. In some implementations, one or more pallet racks 1204 are loaded in the drop deck vehicle trailer 202 (or deep drop deck vehicle trailer 1102). The one or more pallet racks 1204 are configured to receive and support one or more loaded pallets 102. As indicated above, use of the adjustable support members 1152 allows for the height of the drop deck vehicle trailer 202 (or deep drop deck vehicle trailer 1102) to be efficiently and effectively utilized.

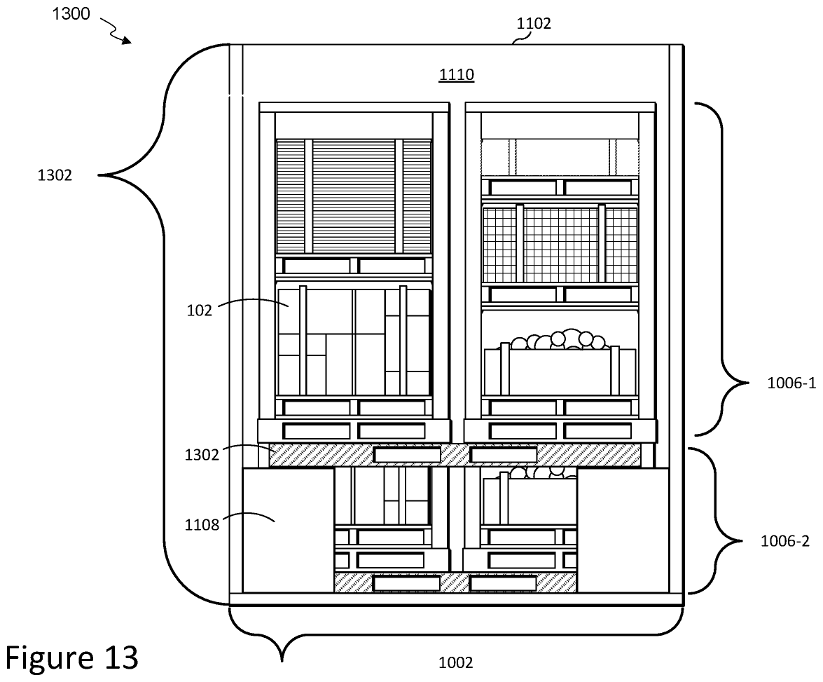

FIG. 13 illustrates a rear view of a loaded deep drop deck vehicle trailer 1102, in accordance with some implementations. The rear view 1300 shows a view of the deep drop deck vehicle trailer 1102 from a freight loading dock 106 (FIGS. 2A-2D). The deep drop deck vehicle trailer 1102 cargo compartment 1110 has a cargo width 1002 (FIG. 10) and a cargo height 1302. The cargo width 1002 of the deep drop deck vehicle trailer 1102 is equal to or substantially equal to the cargo width of the drop deck vehicle trailer 202. Alternatively, the cargo height 1302 of the deep drop deck vehicle trailer 1102 is larger than the cargo height 1004 of the drop deck vehicle trailer 202.

The rear view 1300 further illustrates the deep drop deck vehicle trailer 1102 with at least two wheel wells 1108. The at least two wheel wells 1108 occupy a portion of the cargo compartment 1110 as described above in FIGS. 11A-11C. The at least two wheel wells 1108 are configured to supports one or more loaded pallets 102. In some implementations, an adjustable support member 1152 is positioned over the at least two wheel wells 1108, and used to support a first row of pallets 1006-1. Alternatively, in some implementations, an expanded pallet 1302 is positioned over and rests over the at least two wheel wells 1108. The expanded pallet 1302 is configured to support the first row of pallets 1006-1. In some implementations, the expanded pallet 1302 extends at least 60% of the width of the trailer (i.e., cargo width 1002). In some implementations, the expanded pallet 1302 is forkliftable. In some implementations, the adjustable support member 1152 and/or the expanded pallet 1302 are used as a unitizing platform or beam to load and support a row of pallets 1006 or one or more loaded pallets 102.

The rear view 1300 further shows a second row of pallets 1006-2 placed behind the at least two wheel wells 1108. In some implementations, a second expanded pallet 1302 is used to support and place the second row of pallets 1006-2 behind the at least two wheel wells 1108. Alternatively, in some implementations, the one or more loaded pallets 102 are loaded directly on the trailer floor.

FIG. 14 illustrates a another rear loading view 1400, in accordance with some implementations. The rear loading view 1400 shows a deep drop deck vehicle trailer 1102, a forklift 104, an expanded pallet 1302, one or more adjustable support members 1152, and loaded pallets 102. The deep drop deck vehicle trailer 1102 includes at least two wheel wells 1108. The at least two wheel wells 1108 occupy at least a portion of an interior (e.g., cargo compartment 208) and are separated by a width of the forklift 104 (such that the forklift 104 can fit between the at least two wheel wells 1108).

In some implementations, one or more adjustable support members 1152 are coupled to a plurality of supports 1402 on opposite trailer walls 1404 of the deep drop deck vehicle trailer 1102. The plurality of supports 1402 are built or installed into the trailer walls 1404 of the deep drop deck vehicle trailer 1102. In some implementations, the plurality of supports 1402 are slots, holes, hooks, tracks, and/or rails configured to receive and support ends of the adjustable support members 1152. The plurality of supports 1402 are configured to support the weight of the adjustable support members 1152 and loaded pallets 102 (placed on the adjustable support members 1152 coupled to the plurality of supports 1402). In some implementations, the plurality of supports 1402 are vertical columns, slanted (or angled), a grid pattern, diagonal gird pattern, and/or horizontal rows. In this way, the adjustable support members 1152 can be placed at different positions and orientations within the deep drop deck vehicle trailer 1102 (or drop deck vehicle trailer 202).

In some implementations, the one or more adjustable support members 1152 are positioned horizontally between the opposite walls 1404 and/or parallel to the cargo width 1002 (FIG. 10) of the deep drop deck vehicle trailer 1102. For example, an adjustable support member 1152 can be coupled to corresponding supports of the plurality of supports 1402 (i.e., supports of the same height and at the same position within the deep drop deck vehicle trailer 1102). Alternatively or additionally, in some implementations, the one or more adjustable support members 1152 are positioned diagonally between the opposite walls 1404 and/or diagonal relative to the width of the deep drop deck vehicle trailer 1102 (e.g., cargo width 1002; FIG. 10). For example, an adjustable support member 1152 can be coupled between a first support at a first height on a first wall 1404-1 and a second support at a second height, different from the first height, on a second wall 1404-2. In another example, an adjustable support member 1152 can be coupled between a first support closer to a first section 1104 of the deep drop deck vehicle trailer 1102 and a second support closer to a second section 1106 of the deep drop deck vehicle trailer 1102. In some implementations, the adjustable support members 1152 are adjustable in length. For example, an adjustable support member 1152 may be collapsible for storage. In another example, the adjustable support members 1152 can be extendible such that the adjustable support members 1152 can couple to different plurality of supports 1402 along different positions of the deep drop deck vehicle trailer 1102.

The adjustable support members 1152 are configured to support one or more loaded pallets 252. As shown in rear loading view 1400, an adjustable support member 1152 can be positioned above one or more loaded pallets 102. For example, as shown in rear loading view 1400, one or more adjustable support member 1152 are positioned above one or more loaded pallets 102 behind the at least two wheel wells 1108. By positioning the one or more adjustable support member 1152 over one or more loaded pallets 102, the one or more adjustable support member 1152 allow for additional loaded pallets 102 to be loaded in the deep drop deck vehicle trailer 1102 without resting the loaded pallets on one another. Although not shown, in some implementations, one or more adjustable support member 1152 are positioned to secure one or more loaded pallets 102. For example, one or more loaded pallets 102 can be placed in between at least two adjustable support members 1152, and the adjustable support members 1152 reduce or prevent the one or more loaded pallets 102 from moving.

Further shown in the rear loading view 1400, the forklift 104 is loading the cargo compartment 1110 of the deep drop deck vehicle trailer 1102 with loaded pallets 252. In particular, the forklift 104 is carrying an expanded pallet 1302 with a row of pallets 1006 (FIG. 10) loaded on the expanded pallet 1302 into the cargo compartment 1110. Alternatively, in some implementations, the forklift 104 can use an adjustable support member 1152 to load the row of pallets 1006 in the cargo compartment 1110. In some implementations, the movement of the forklift 104 is restricted by the at least two wheel wells 1108. More specifically, the forklift's 104 movement may be limited to the center aisle (i.e., the space between the at least two wheel wells 1108) due to the position of the least two wheel wells 1108. The forklift 104 is able to safely and efficiently load or unload loaded pallets 102 on either side of the deep drop deck vehicle trailer 1102 (e.g., on the at least two wheel wells 1108) with its limited movement. In some implementations, the extended pallet 1302 or the adjustable support member 1152 (with the row of pallets 1006) is loaded on the at least two wheel wells 1108. Additionally, in some implementations, the forklift 104 loads an area in front of the at least two wheel wells 1108 with loaded pallets 102.

FIGS. 15A and 15B illustrate a first and second plurality of supports, in accordance with some implementations. A first plurality of supports 1500 includes one or more slots (or holes) diagonally spaced. For example, the first plurality of supports 1500 includes alternating rows with different number of slots (e.g., a row of 4 slots followed by a row of three slots). Each wall of the drop deck vehicle trailer 202 includes the first plurality of supports 1500. In this way, the first plurality of supports 1500 on each wall align (e.g., share the same axis). As described above in FIG. 14, the first plurality of supports are configured to receive and support one or more adjustable support members 1152 (and loaded pallets 102 placed thereon).

The first plurality of supports 1500 allows the one or more adjustable support members 1152 to be placed in different positions. For example, an adjustable support member 1152 can be coupled to corresponding support members of the first plurality of supports 1500 on each wall such the adjustable support member 1152 is parallel to the width of the drop deck vehicle trailer 202 (i.e. cargo width 1002; FIG. 10). Alternatively, an adjustable support member 1152 can be coupled to a support members at different positions along the first wall and the second wall such the adjustable support member 1152 is diagonal with respect to the width of the drop deck vehicle trailer 202. The first plurality of supports 1500 provides a user with the flexibility to attach the one or more adjustable support members 1152 in any position needed.

A second plurality of supports 1550 includes one or more slots (or holes) equally spaced. For example, the second plurality of supports 1500 includes rows with the same number of slots. The second plurality of supports 1550 are included in each wall 1404 of the drop deck vehicle trailer 202, and are configured to receive and support one or more adjustable support members 1152 as described above with respect to the first plurality of supports 1500. The second plurality of supports 1550 illustrate an alternate approach for coupling the adjustable support members 1152 to the drop deck vehicle trailer 202. The examples provided above in FIGS. 15A and 15B are non-exhaustive, and different patterns and/or positioning of the supports of the plurality of supports can be used.

FIGS. 16A and 16B illustrates different lift mechanisms, in accordance with some implementations. A first view 1600 shows a drop deck vehicle trailer 202 including a lift mechanism 212, a freight dock 106, and a forklift 104. The drop deck vehicle trailer 202 includes a first section 204 and a second section 206. In some implementations, the second section 206 includes the lift mechanism 212. Additionally, in some implementations, the first section 204 includes an additional lift mechanism 1602.

As described above in reference to FIGS. 2A-2D, the lift mechanism 212 is configured to adjust the height of at least the second section 206 such that it is equal or substantially equal to the height of the freight dock 106. In particular, the suspension is expanded to increasing the distance between the tires (that, in some implementations, remain on the ground) and the body of the drop deck vehicle trailer 202. By adjusting the height of at least the second section 206, the forklift 104 is able to enter a cargo compartment 208 of the drop deck vehicle trailer 202. In this way, the drop deck vehicle trailer 202 can be loaded via the freight dock 106 instead of requiring the use of customized or specialized freight docks, or requiring the drop deck vehicle trailer 202 to be loaded by hand or from the ground.

In some implementations, the lift mechanism 212 included in the second section 206 is an airbag 1604 configured to raise the height of the second section 206 of the drop deck vehicle trailer 202 to the height of the freight dock 106. The airbag 1604 is configured to expand (or contract) a predetermined amount, (e.g., 10 in./min. or other amount). The airbag can be controlled by a user near and/or at the second section 206, the freight dock 106, and/or driver's cockpit.

In some implementations, the additional lift mechanism 1602 at the first section 204 is configured to be extended and level the overall height of drop deck vehicle trailer 202 with the freight dock 106 (i.e., make the trailer floor parallel with the ground and/or freight dock 106). In some implementations, the additional lift mechanism 1602 is a front landing gear 1606 (or extendable jack). In some implementations, the front landing gear is configured to expand (or contract) a predetermined amount, (e.g., 10 in./min. or other amount). The front landing gear can be controlled by a user near and/or at the first section 204, the freight dock 106, and/or driver's cockpit. The additional lift mechanism 1602 at the first section 204 can be controlled independently from the lift mechanism 212 at the second section 206. The additional lift mechanism 1602 is raised when the drop deck vehicle trailer 202 is resting on a truck tractor (no shown), such that the tractor trailer can drive (without interference with the additional lift mechanism 1602).

In a second view 1650, an alternate lift mechanism at the second section 206 is a rear landing gear 1652 (or extendable jack). In some implementations, the rear landing gear 1652 is lowered or raised to adjust the height of the drop deck vehicle trailer 202 with the freight dock 106. The rear landing gear 1652 is configured to perform the same or similar functions as the airbag 1604.

It should be noted that the lift mechanism 212 can be any device that extend a suspension of the drop deck vehicle trailer 202. For example, the lift mechanism 212 can be a hydraulic lift, electric mechanical lift, or mechanic lift. The different lift mechanism 212 types perform the same or similar functions as those described above in FIGS. 16A and 16B.

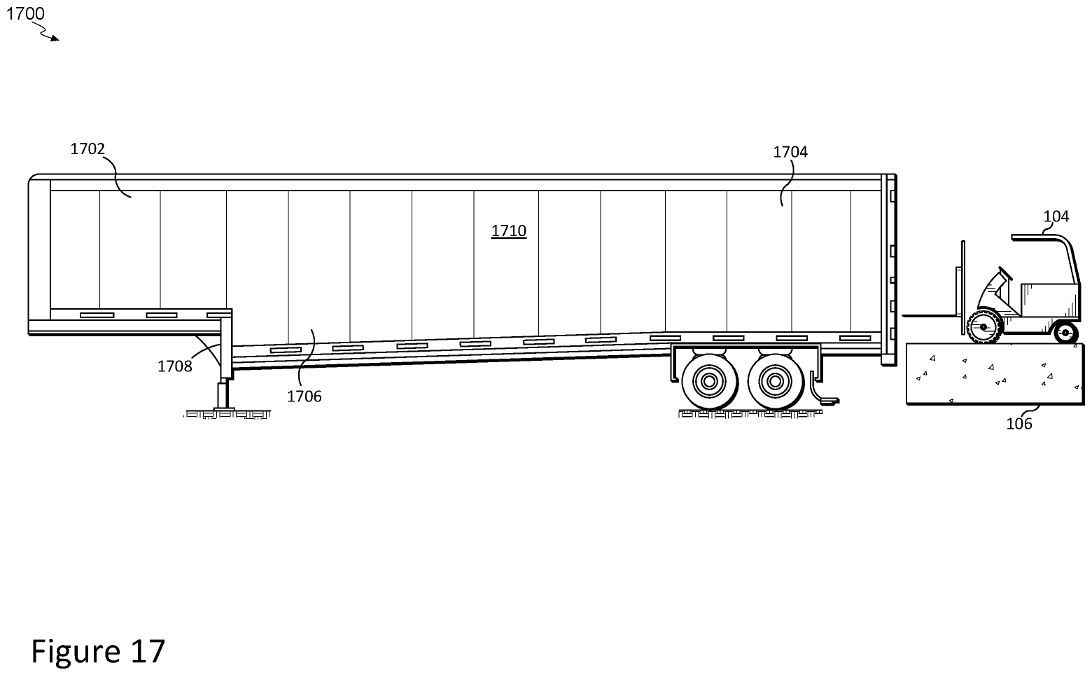

FIG. 17 illustrates an alternative drop deck vehicle trailer with at least three sections, in accordance with some implementations. The alternative drop deck vehicle trailer 1700 includes one or more features of a drop deck vehicle trailer 202 (FIGS. 2A-2D) and/or a deep drop deck vehicle trailer 1102 (FIGS. 11A-11C). For example, the alternative drop deck vehicle trailer 1700 has a trailer floor including a first section 1702 and a second section 1704 similar to the those of the drop deck vehicle trailer 202 (FIGS. 2A-2D) and/or the deep drop deck vehicle trailer 1102. Furthering the example, the second section 1704 may or may not include at least two wheel wells 1108. Additionally, the alternative drop deck vehicle trailer 1700 may include any other features described above in reference to FIGS. 2A-16B.

The alternative drop deck vehicle trailer 1700 includes a third section 1706 between the first section 1702 and second section 1704. In particular, the third section 1706 has a first end adjacent to the first section 1702; and a second end, opposite the first end, adjacent to the second section 1704. In some implementations, the third section 1706 includes a third height that is different from a first height (similar to the first height of the first sections of FIGS. 2A-2D and 11A-11C) of the first section 1702 and a second height (similar to the second height of the first sections of FIGS. 2A-2D or 11A-11C) of the second section 1704. In particular, the third height is less than the first and second heights. In some implementations, the

In some implementations, the alternative drop deck vehicle trailer 1700 includes a predetermined vertical drop 1708. In some implementations, the predetermined vertical drop 1708 is at least 30 in. (+/−6 to 9 in.). Similar to the description of FIGS. 2A-2D, the predetermined vertical drop 1708 is equal to the difference between the first height of the first section 1702 and the second height of the second section 1704. The predetermined vertical drop 1708 further increases the effective ceiling height in a cargo compartment 1710 of the alternative drop deck vehicle trailer 1700. More specifically, the specific height of the effective ceiling height in the cargo compartment 1710 increases from the second section 1704 and the third section 1706. In some implementations, the change between the first height and the third height is discrete (e.g., a single change or jump). In some implementations, the change between the second height and the third height is continuous. For example, as shown by the alternative drop deck vehicle trailer 1700, the trailer floor has a slope going from the second height to the third height. The predetermined vertical drop 1708 is configured to allows a forklift 104 to load or unload loaded pallets 102 on the first section 1702 in the same manner as described in reference to FIGS. 2A-2D and 11A-11C.

In some implementations, the alternative drop deck vehicle trailer 1700 includes a lift mechanism 212 as described above. In some implementations, the lift mechanism 212 is used to level the trailer floor of the alternative drop deck vehicle trailer 1700. For example, the lift mechanism 212 can be used to adjust a slope of the floor of the alternative drop deck vehicle trailer 1700 such that it is parallel with a freight dock 106. More specifically, the lift mechanism 212 can be used to remove the slope generated between the second section 1704 and the third section 1706.

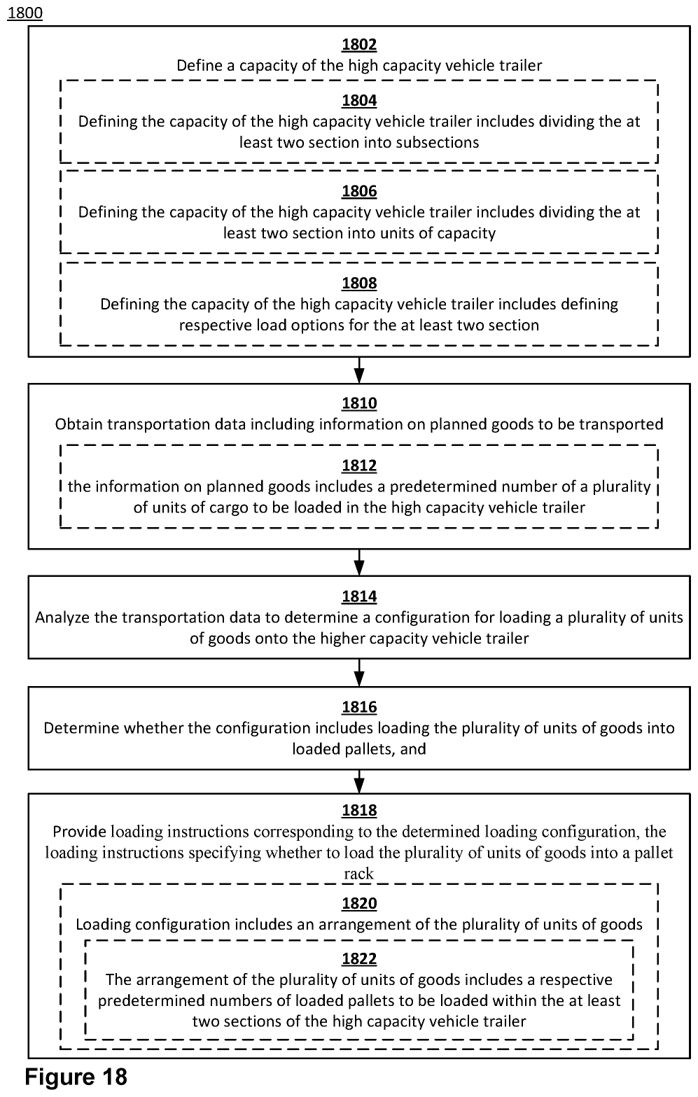

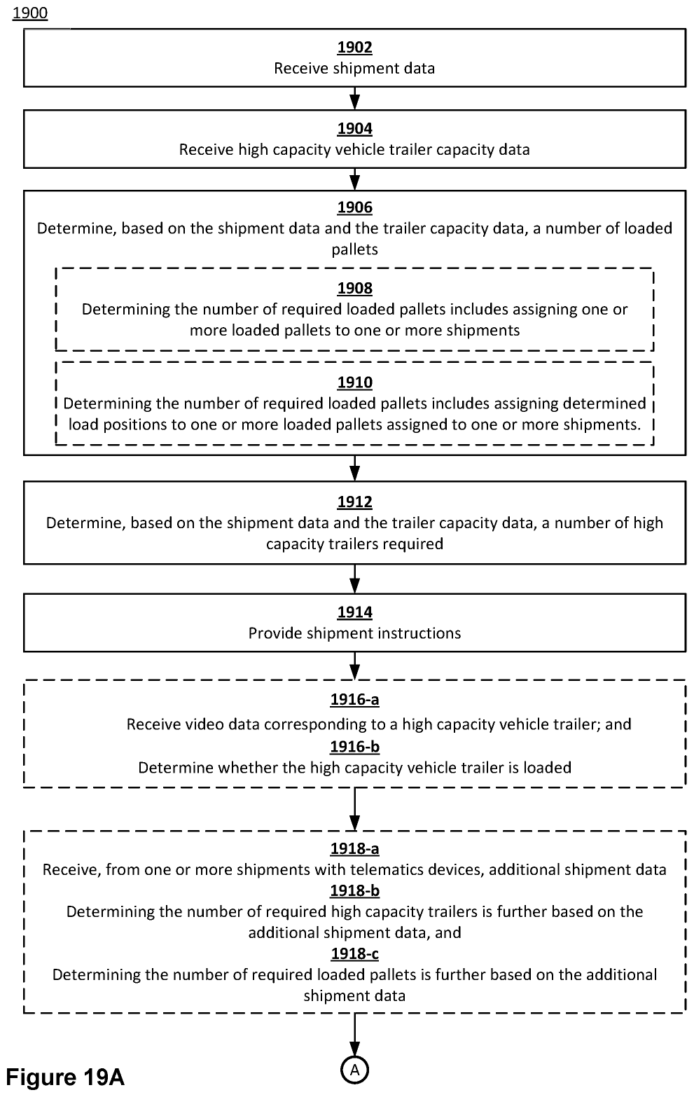

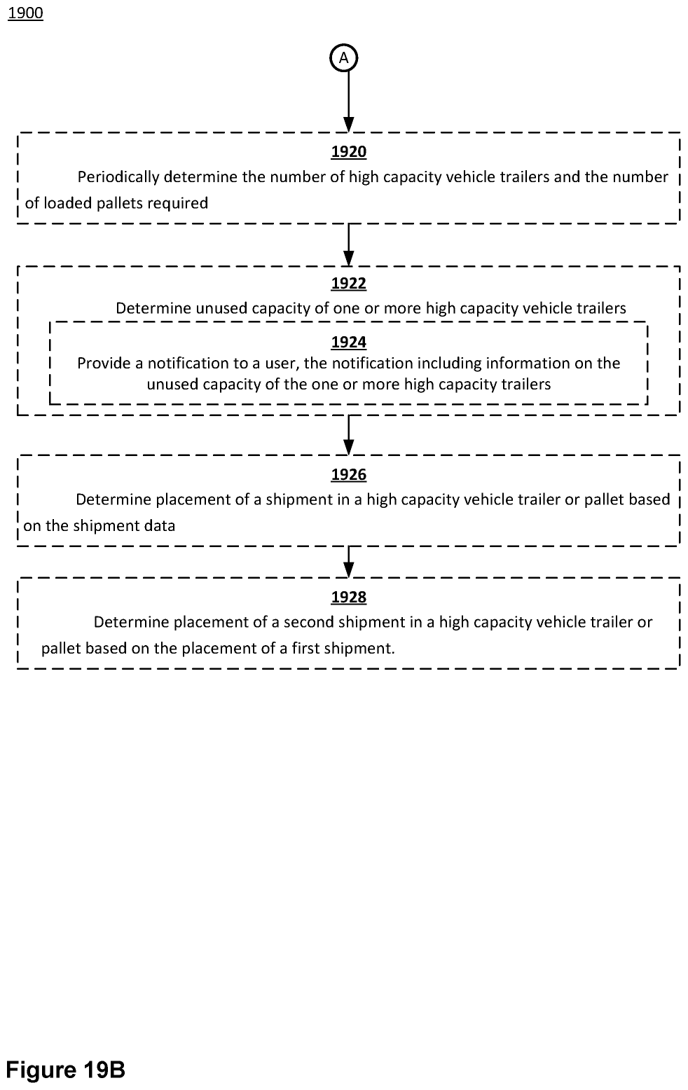

FIGS. 18-19B are flow charts illustrating methods for loading or unloading a high capacity vehicle trailer (e.g., drop deck vehicle trailer 202, deep drop deck vehicle trailer 1102, or alternative drop deck vehicle trailer 1700), in accordance with some implementations. The methods described below may be performed at one or more servers and/or computer devices as discussed above in reference to FIGS. 2A-2D. Methods consistent with the present disclosure may include at least some, but not all, of the operations illustrated in FIGS. 18-19B, performed in a different sequence. Furthermore, methods consistent with the present disclosure may include at least two or more steps performed overlapping in time, or almost simultaneously. For brevity, the different operations of FIGS. 18-19B described below are performed at a server.

A method 1800 of loading a high capacity vehicle trailer (consistent with FIGS. 2A-2D, 11A-11C, and 17) includes defining (1802) a capacity of the high capacity vehicle trailer. In some implementations, defining the capacity of the high capacity vehicle trailer includes obtaining, from a user, information corresponding to the high capacity vehicle trailer. The information corresponding to the high capacity vehicle trailer can include the high capacity vehicle trailer type, current capacity of the high capacity vehicle trailer, available capacity of the high capacity vehicle trailer, types of goods being carried by the high capacity vehicle trailer, dimensions, sizes, and weights of the goods currently being carried by the high capacity vehicle trailer, additional weight that can be carried by the high capacity vehicle trailer, number of loaded pallets 102 currently being carried by the high capacity vehicle trailer, number of additional loaded pallets 102 that can be carried by the high capacity vehicle trailer, and other relevant information.

In some implementations, defining the capacity of the high capacity vehicle trailer includes dividing (1804) the at least two section into subsections. For example, the server may subdivide a first section 204 and a second section 206 of a drop deck vehicle trailer 202 (FIG. 2) into an upper section and a lower section. In this way, the server can define the available capacity over the trailer floor. In another example, the server can subdivide the second section 206 into a plurality of subsections such that loaded pallets 102 and/or other goods can be organized, loaded, and/or unloaded based on subsections. In some implementations, defining the capacity of the high capacity vehicle trailer includes dividing (1806) the at least two section into units of capacity. For example, the server may divide a first section 1104 of a deep drop deck vehicle trailer 1102 (FIG. 11) into a number of rows of pallets 1006 (FIG. 10) that the first section 1104 can carry. In some implementations, defining the capacity of the high capacity vehicle trailer includes defining (1808) respective load options for the at least two section. For example, the server may determine that a third section 1706 of an alternative drop deck vehicle trailer 1700 (FIG. 17) can carry at least two additional levels of loaded pallets 102 (supported by respective adjustable support members 1152) over a loaded pallet 102 resting on the trailer floor. In another example, the server may determine that at a row of pallets 1006 with three loaded pallets 102 can be positioned over at least two wheel wells 1108.

The method includes obtaining (1810) transportation data, including information on planned goods to be transported. In some implementations, transportation data includes the number of goods to be transported, dimensions, sizes, and weights of the goods to be transported, types of goods to be transported, whether the goods can be unitized (e.g., carried in a pallet rack, Gaylord, or other device), a number (or estimated number) of loaded pallets 102 to be transported, and other relevant information. In some implementation, the information on planned goods includes (1812) a predetermined number of a plurality of units of goods to be loaded in the high capacity vehicle trailer (i.e. individualized units of goods).

The method includes analyzing (1814) the transportation data to determine a configuration for loading the plurality of units of goods in the higher capacity vehicle trailer, and determining (1816) whether the configuration includes loading the plurality of units of goods into loaded pallets 102 (or a pallet rack units, or other unitizing cargo unit). For example, the server may determine that the drop deck vehicle trailer 202 has available space for three rows of pallets 1006, where the available space is split between the first section 204 and the second section 206. The server may further determine which rows of pallets 1006 should be placed in the first and second section 206 and how they should be positioned, organized, and/or stowed. In this way, the server determines an efficient way to load the plurality of loaded pallets 102 in the higher capacity vehicle trailer. Furthering the example, the server can determine whether the goods should be loaded in pallet racks and/or other cargo unitizing device. In this way, individualized units of goods can be consolidated into a single unit to increase the total carrying capacity.

The method includes providing (1818) loading instructions corresponding to the determined loading configuration, the loading instructions specifying whether to load the plurality of units of goods into a pallet rack. More specifically, the server provides, to a user, the load configuration information for positioning, organizing, moving, stacking, storing, etc. loaded pallets 102, goods, and/or other cargo to be transported. In some implementations, the loading configuration includes (1818) an arrangement of the plurality of goods. In particular, the server provide instructions for loading the goods in loaded pallets 102, pallet racks, etc., and how the goods should be loaded in the high capacity vehicle trailer. In some implementations, the arrangement of the plurality of goods includes (1820) a respective predetermined numbers of loaded pallets 102, pallet rack units, or other devices to unitize cargo to be loaded within the at least two sections of the high capacity vehicle trailer. In some implementations, the arrangement of the plurality of goods includes instructions on how the plurality of goods should be positioned in each section.

A method 1900 of determining loading configurations of a high capacity vehicle trailer includes receiving (1902) shipment data. In some implementations, the shipment data includes information corresponding to a number of shipments, the start location of each shipment, the end location of each shipment, the service commitment for each shipment (e.g., type of service, such as white glove service, temperature control service, signature-authorization, etc.), transit times committed (e.g., overnight shipping, 2 day shipping, rush shipping, etc.). Additionally, in some implementations, the shipment data includes information corresponding to type of goods to be transported, the quantity of goods, the size and/or dimensions of goods, and/or other information corresponding to the goods to be loaded in the drop deck vehicle trailer 202. Additional information on the shipment information is provided above in FIGS. 2A-2D. The method 1900 includes receiving (1904) high capacity vehicle trailer capacity data. The high capacity vehicle trailer capacity data is described above in reference to FIGS. 2A-2D and FIG. 18.

Then method 1900 includes determining (1906), based on the shipment data and the high capacity vehicle trailer data, a number of loaded pallets 102 required. For example, server may determine that a shipment with a predetermined number of goods will need a predetermined number of loaded pallets 102 (which can be used to consolidate the goods). In some implementations, determining the number of loaded pallets 102 required includes assigning (1908) one or more loaded pallets to one or more shipments. In particular, the server may assign one or more loaded pallets to respective shipments that will be transported by one or more high capacity vehicle trailers. In some implementation, determining the number of loaded pallets 102 required includes assigning (1910) determined load positions to one or more loaded pallets assigned to one or more shipments. For example, the server may determine an order, position, organization, and configurations for loading the loaded pallets 102 in a high capacity vehicle trailer. Additional examples, are provided above in FIGS. 2A-2D and FIG. 18. In some implementations, the method includes determining a plurality of options for the loaded pallets 102, each option for the loaded pallets 102 including a different predetermined number of loaded pallets 102 and configurations for the loaded pallets 102. In some implementations, each option for the loaded pallets 102 is scored based on efficiency.

In some implementations, the method includes determining (1912), based on the shipment data and the trailer capacity data, a number of high capacity trailers required. For example, the server may determine that a shipment may require two high capacity vehicle trailers to be completed. The number of high capacity vehicle trailer needed can be an entire high capacity vehicle trailer or a portion thereof. For example, a shipment may require 2.5 high capacity vehicle trailer to be completed. Additionally, in some implementations, the method includes determining a plurality of options for the high capacity vehicle trailer, each option including a different predetermined number of high capacity vehicle trailer and/or high capacity vehicle trailer type. In some implementations, each option is scored based on efficiency. In some implementations, the server determines a suggested option based on a combination of the plurality of options for the high capacity vehicle trailer and the plurality of options for the loaded pallets 102. In this way, the server can determine an ideal configuration for transporting a shipment.

The method includes providing (1914) shipment instructions. In particular, the server provides to a user instructions on the number of loaded pallets 102 that should be used, the number of options for the high capacity vehicle trailer that are needed, how the loaded pallets 102 should be positioned, organized, stored, moved, stacked, etc. For example, the server may provide shipping instructions for a pickup and drop off sequence (as described above in FIGS. 2A-2D).

In some implementations, the method 1900 further includes receiving (1916-a) video data, from a digital camera system of high capacity vehicle trailers, corresponding to a high capacity vehicle trailer, and determining (1916-b) whether the high capacity vehicle trailer is loaded. In particular, the server can perform video processing on the video data to determine whether there is any available space in the high capacity vehicle trailer or if the high capacity vehicle trailer is fully loaded. Additionally, in some implementations, the video data is used for securing loaded pallets 102 in the high capacity vehicle trailer. For example, the server can perform video processing on the video data to perform facial recognition (identifying authorized or unauthorized personnel), determine movement of the loaded pallets 102, determine whether loaded pallets 102 have fallen, are damaged, or are missing, etc. In some implementations, the video data is used, with the shipment data, to determine the number of high capacity trailers and/or the number of loaded pallets required. The digital camera system is discussed above with respect to FIGS. 2A-2D.

In some implementations, the method 1900 further includes receiving (1918-a), from one or more shipments with telematics devices, additional shipment data. The method 1900 includes determining (1918-b) the number of high capacity trailers and/or the determining (1918-c) the number of loaded pallets required based on the additional shipment data and the shipping data. In some implementations, telematics devices includes one or more sensors (e.g., thermal radiation sensors, ambient temperature sensors, humidity sensors, IR sensors, occupancy sensors (e.g., RFID sensors), ambient light sensors, motion detectors, accelerometers, and/or gyroscopes), trackers, GPS, and/or other data collecting device. As a non-limiting example, the server may use sensor data (e.g., weight data) to determine additional loaded pallets 102 that can be loaded to the high capacity vehicle trailer. As another example, the sensor data (e.g., weight data) can be used to determine the distribution of weight in the high capacity vehicle trailer and/or whether loaded pallets 102 have been removed from high capacity vehicle trailer. The telematics devices is discussed above with respect to FIGS. 2A-2D.

In some implementations, the method 1900 includes periodically determining (1920) the number of high capacity vehicle trailers and the number of loaded pallets required. For example, the number of high capacity vehicle trailers and the number of loaded pallets can be updated based on updated data (provided by the user and/or collected from digital camera systems and/or telematics devices). In some implementations, the method 1900 includes determining (1922) unused capacity of one or more high capacity vehicle trailers. The method 1900 further includes providing (1924) a notification to a user. The notification includes information on the unused capacity of the one or more high capacity trailers. In some implementations, the notification is provided to a shipper and/or a carrier.

In some implementations, the method 1900 includes determining (1926) placement of a shipment in a high capacity vehicle trailer or pallet based on the shipment data. For example, the server can receive shipment data for three shipments and determine that the first and third shipments should be assigned to a first high capacity vehicle trailer and the second shipment should be assigned to a second high capacity vehicle trailer. In some implementations, the method 1900 includes determining (1928) placement of a second shipment in a high capacity vehicle trailer or loaded pallet 102 based on the placement of a first shipment. More specifically, the server can dynamically determine the placement of a shipment based on previous assignments of shipments. For instance, continuing the example above, the server may receive shipping data on a fourth shipment and determine that the first shipment, second shipment, and fourth shipment should be assigned to the first high capacity vehicle trailer, and the third shipment should be assigned to the second high capacity vehicle trailer. The method 1900 further includes providing the user with the updated shipment instructions.

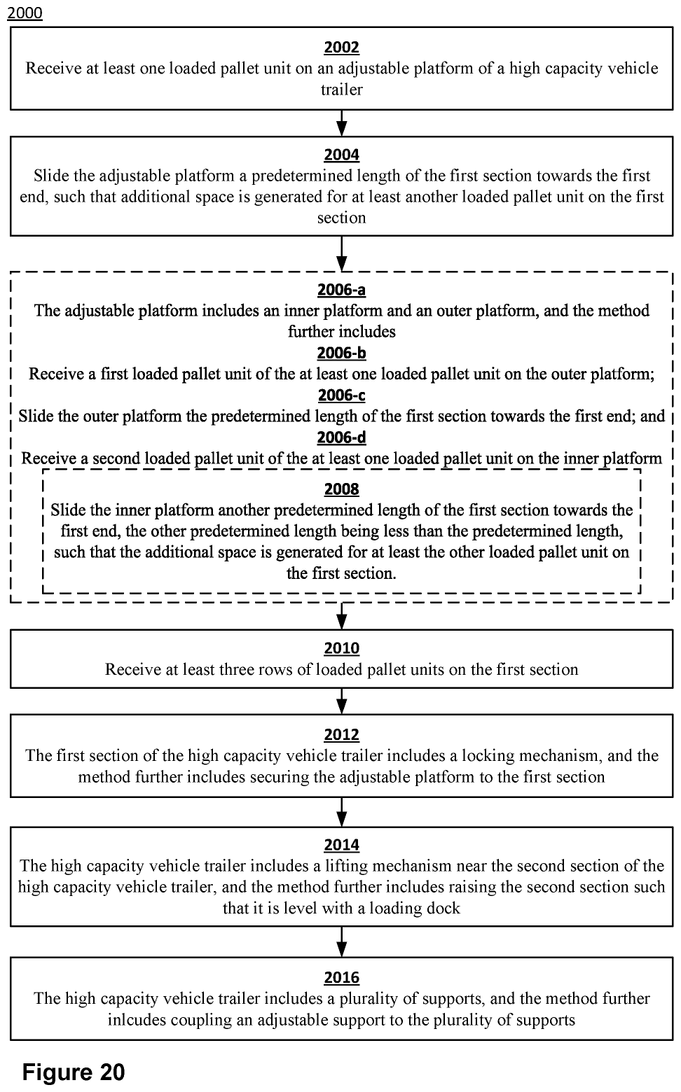

FIG. 20 is a flow chart illustrating a method of loading or unloading a high capacity vehicle trailer (e.g., drop deck vehicle trailer 202, deep drop deck vehicle trailer 1102, or alternative drop deck vehicle trailer 1700), in accordance with some implementations. Methods consistent with the present disclosure may include at least some, but not all, of the operations illustrated in FIGS. 18-20, performed in a different sequence. Furthermore, methods consistent with the present disclosure may include at least two or more steps performed overlapping in time, or almost simultaneously. For brevity, the different operations of FIG. 20 described below are performed with a drop deck vehicle trailer 202.

A high capacity vehicle trailer includes (e.g., drop deck vehicle trailer 202; FIG. 2) a trailer floor including at least two sections. The at least two sections include a first section (e.g. first section 204; FIG. 2) located at a first end of the high capacity trailer, the first section having a first height; and a second section (e.g. second section 206; FIG. 2) located at a second end of the high capacity vehicle trailer opposite the first end, the second section having a second height different from the first height. The high capacity vehicle trailer further includes an adjustable platform (e.g. adjustable platform 210; FIG. 2) positioned at the first section. A method 2000 of loading the high capacity vehicle trailer includes receiving (2002) at least one loaded pallet unit on the adjustable platform, and sliding (2004) the adjustable platform a predetermined length of the first section towards the first end, such that additional space is generated for at least another loaded pallet unit on the first section.

In some implementations, the adjustable platform includes (2006-a) an inner platform and an outer platform (e.g. FIGS. 2A-3B), and the method 2000 further includes receiving (2006-b) a first loaded pallet unit of the at least one loaded pallet unit on the outer platform, sliding (2006-c) the outer platform the predetermined length of the first section towards the first end; and receiving (2006-d) a second loaded pallet unit of the at least one loaded pallet unit on the inner platform. In some implementations, the method includes sliding (2008) the inner platform another predetermined length of the first section towards the first end. The other predetermined length is less than the predetermined length, such that the additional space is generated for at least the other loaded pallet unit on the first section. Additional examples are provide above in reference to FIGS. 4A-4C.

In some implementations, the method 2000 includes receiving (2010) at least three rows of loaded pallet units on the first section. In some implementations, the first section includes a locking mechanism, and the method 2000 includes securing (2012) the adjustable platform to the first section. In some implementations, the high capacity vehicle trailer includes a lifting mechanism near the second section, and the method 2000 includes raising (2014) the second section such that it is level with a loading dock. In some implementations, the high capacity vehicle trailer includes a plurality of supports, and the method 2000 includes coupling (2016) an adjustable support to the plurality of supports.

All of these examples are non-limiting and any number of combinations and multi-layered structures are possible using the example structures described above. Further implementations also include various subsets of the above implementations including implementations in FIGS. 1-20 combined or otherwise re-arranged in various implementations, as one of skill in the art will readily appreciate while reading this disclosure.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A high capacity vehicle trailer comprising:
a trailer floor including at least two sections, the at least two sections comprising:
a first section located at a first end of the high capacity trailer, the first section having a first height, and
a second section located at a second end of the high capacity vehicle trailer opposite the first end, the second section having a second height different from the first height; and
an adjustable platform positioned at the first section, the adjustable platform configured to:
receive at least one loaded pallet unit, and
slide a predetermined length of the first section towards the first end, such that additional space is generated for at least another loaded pallet unit on the first section.

2. The high capacity vehicle trailer of claim 1, wherein
the first section of the high capacity vehicle trailer includes a channel extending along the predetermined length, and
the adjustable platform includes one or more wheels configured to slide along a path of the channel.

3. The high capacity vehicle trailer of claim 2, wherein:
the channel includes at least two rails, and
the one or more wheels of the adjustable platform rest on the at least two rails.

4. The high capacity vehicle trailer of claim 1, wherein the trailer floor of the first section is comprised of a low friction material configured to allow the adjustable platform to slide at least partially the first length of the first section towards the first end with a predetermined force, the predetermined force being less than a substantial force.

5. The high capacity vehicle trailer of claim 1, wherein the trailer floor of the first section includes a plurality of rollers configured to allow the adjustable platform to be moved at least partially across the first length of the first section towards the first end with a predetermined force, the predetermined force being less than a substantial force.

6. The high capacity vehicle trailer of claim 1, wherein the adjustable platform includes an inner platform and an outer platform, the outer platform being configured to be loaded first and slide the predetermined length of the first section towards the first end before the inner platform is loaded.

7. The high capacity vehicle trailer of claim 1, wherein the inner platform is configured to be slide another predetermined length of the first section towards the first end, the other predetermined length being less than the predetermined length, such that the additional space is generated for at least the other loaded pallet unit on the first section.

8. The high capacity vehicle trailer of claim 1, wherein the first section is configured to receive at least three rows of loaded pallets.

9. The high capacity vehicle trailer of claim 1, wherein the first section includes a locking mechanism for securing the adjustable platform.

10. The high capacity vehicle trailer of claim 1, wherein the second section includes at least two wheel wells that occupy at least a portion of an interior of the vehicle trailer.

11. The high capacity vehicle trailer of claim 10, wherein the second height of the second section is lower than a height of the top of the at least two wheel wells.

12. The high capacity vehicle trailer of claim 10, wherein the at least two wheel wells are separated by a width of a forklift.

13. The high capacity vehicle trailer of claim 1, further comprising:
a third section between the first section and second section, wherein
the third section includes a third end and a fourth end, the third end being adjacent to the first section, and the fourth end being adjacent to the second section;
the third end has a third height less than the second height; and
the fourth end has the same height as the second height.

14. The high capacity vehicle trailer of claim 1, wherein the first and second heights are fixed.

15. The high capacity vehicle trailer of claim 1, wherein the first height is greater than the second height.

16. The high capacity vehicle trailer of claim 1, further comprising a lifting mechanism near the second section, the lifting mechanism configured to raise the second section such that it is level with a loading dock.

17. The high capacity vehicle trailer of claim 16, wherein the lifting mechanism is an airbag, hydraulic, or electric mechanical lift.

18. The high capacity vehicle trailer of claim 16, wherein the lifting mechanism is an extendable jack.

19. A method of loading a high capacity vehicle trailer, the high capacity vehicle trailer including a trailer floor including at least two sections, the at least two sections including a first section located at a first end of the high capacity trailer, the first section having a first height, and a second section located at a second end of the high capacity vehicle trailer opposite the first end, the second section having a second height different from the first height, and an adjustable platform positioned at the first section, the method comprising:
defining a capacity of the high capacity vehicle trailer;
obtaining transportation data including information on planned goods to be transported;
analyzing the transportation data to determine a configuration for loading a plurality of units of goods onto the higher capacity vehicle trailer;
determining whether the configuration includes loading the plurality of units of goods into a pallet rack; and
providing loading instructions corresponding to the determined loading configuration, the loading instructions specifying whether to load the plurality of units of goods into a pallet rack.

20. A method of loading a high capacity vehicle trailer including a trailer floor including at least two sections, the at least two sections including a first section located at a first end of the high capacity trailer, the first section having a first height, and a second section located at a second end of the high capacity vehicle trailer opposite the first end, the second section having a second height different from the first height, and an adjustable platform positioned at the first section, the method comprising:
receiving at least one loaded pallet unit on the adjustable platform,
sliding the adjustable platform a predetermined length of the first section towards the first end, such that additional space is generated for at least another loaded pallet unit on the first section.
